(19) United States
(12) Patent Application Publication
(10) Pub. No.: US 2026/0094282 A1
(43) Pub. Date: Apr. 2, 2026

(54) SELECTION STRATEGIES FOR INTERACTION WITH PHYSICAL OBJECTS IN AN ENVIRONMENT

(71) Applicant: Apple Inc., Cupertino, CA (US)

(72) Inventors: Guilherme KLINK, Campbell, CA (US); Paulo R. JANSEN DOS REIS, San Jose, CA (US); Tigran KHACHATRYAN, North Hills, CA (US); Ashwin K. VIJAY, Sunnyvale, CA (US); Peter BURGNER, Venice, CA (US)

(21) Appl. No.: 19/329,377

(22) Filed: Sep. 15, 2025

Related U.S. Application Data
(60) Provisional application No. 63/700,661, filed on Sep. 28, 2024.

(51) Int. Cl. G06T 7/20; G06V 40/20; H04N 23/611

(52) U.S. Cl. CPC G06T 7/20; G06V 40/28; H04N 23/611

(57) ABSTRACT

Some examples of the disclosure are directed to systems and methods for presenting one or more user interface elements including second information related to first information found in an indicated region of the physical environment. In some examples, after confirming that the electronic device meets one or more first criteria, the electronic device captures one or more first images of the physical environment, including a first region which includes information. After confirming that one or more second criteria are satisfied (e.g., corresponding to an object-interaction gesture), the electronic device initiates image processing to generate second information related to the first information.

### CROSS REFERENCE TO RELATED APPLICATIONS

This application claims the benefit of U.S. Provisional Application No. 63/700,661, filed Sep. 28, 2024, the content of which is herein incorporated by reference in its entirety for all purposes.

### FIELD OF THE DISCLOSURE

The present disclosure generally relates to systems and methods for efficient selecting and interacting with information.

### BACKGROUND OF THE DISCLOSURE

Some computer graphical environments provide two-dimensional and/or three-dimensional environments where at least some objects displayed for a user's viewing are virtual and generated by a computer. In some examples, a physical environment (e.g., including one or more physical objects) is presented, optionally along with one or more virtual objects, in a three-dimensional environment.

### SUMMARY OF THE DISCLOSURE

Some examples of the disclosure are directed to systems and methods for the interaction with the physical environment of an electronic device. In some examples, the interaction includes an input gesture that is detected in connection with an object in the physical environment. For example, the input gesture optionally corresponds to an object-interaction gesture including a pointing gesture directed at an object. For example, the object-interaction gesture optionally includes a pointing gesture by a finger (e.g., an index finger or optionally another finger) of a hand of the user (optionally also with the remaining fingers in a fist) pointing at object. In some examples, the object-interaction gesture includes touching the object or being within a threshold distance of the object. In some examples, performing the object-interaction gesture includes maintaining the pointing gesture (e.g., optionally with less than a threshold amount of movement, and/or optionally with gaze directed at the object or the hand) for a threshold amount of time. Although a pointing gesture is primarily shown and described herein, it is understood that the object-interaction gesture described herein is not so limited. In some examples, the electronic device provides relevant information related (e.g., displays the information as virtual content in a user interface or otherwise in a three-dimensional environment) to the information identified and detected in the physical environment. In some examples, the electronic device is a head worn electronic device.

In some examples, the present disclosure provides efficient methods for applying processes (e.g., gating strategies) to limit undue execution of processes or operations until one or more criteria are satisfied, or one or more cues are detected. For example, one or more gating strategies are optionally used to limit undue execution of processes to detect an object-interaction gesture, and/or the additional processing necessary to perform the operations associated with the object-interaction gesture. By awaiting confirmation of satisfaction of criteria and/or detection of cues prior to executing subsequent operations, the present disclosure provides efficient gating strategies to limit unnecessary processes which are otherwise potentially costly with respect to processor tasking and power consumption.

In some examples, a method is performed at an electronic device in communication with one or more displays and/or a plurality of input devices including one or more motion sensors and one or more optical sensors. In some examples, the electronic device detects movement of the electronic device using one or more motion sensors. In some examples, the electronic device determines whether the movement of the electronic device satisfies one or more first criteria, including a criterion that is satisfied when the movement is less than a first threshold of movement (and/or including a criteria that is satisfied when the movement is greater than a second threshold of movement). When the electronic device determines that the one or more first criteria are met, the electronic device captures, via the one or more optical sensors, one or more first images of a physical environment. In some examples, when the electronic device determines that the one or more first criteria are met, the electronic device initiates tracking for a first portion of a user (e.g., a finger, and/or hand) of the electronic device (e.g., as part of detection of an object-interaction gesture) using the one or more first images. In some examples, when the electronic device detects, in the one or more first images, that the first portion of a user of the electronic device satisfies one or more second criteria, the electronic device allows the execution of subsequent operations. In some examples, following the determination that the one or more second criteria are met, the electronic device captures, via the one or more optical sensors, one or more second images of the physical environment, and subsequently, or simultaneously, initiates image processing of a portion of the one or more second images with processes such as, but not limited to, Optical Character Recognition (OCR), non-character recognition, graphical content searching, and Artificial Intelligence (AI) driven search. OCR, graphical content searching, and/or AI driven searching are optionally used to obtain information from the object of the object-interaction gesture and/or additional information associated with the object of the object-interaction gesture.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3H illustrate various examples of an electronic device and user interactions with the electronic device, and optionally displaying a user interface element with information associated with an identified region of a physical environment, according to some examples of the disclosure.

FIGS. 4A-4C illustrates a flow diagram for an example process for an electronic device detecting user interactions with the physical environment according to some examples of the disclosure.

FIG. 5 illustrates a flow diagram for an example process for gating processing algorithms of an electronic device in the context of the object-interaction gesture according to some examples of the disclosure.

### DETAILED DESCRIPTION

Some examples of the disclosure are directed to systems and methods for the interaction with the physical environment of an electronic device. In some examples, the interaction includes an input gesture that is detected in connection with an object in the physical environment. For example, the input gesture optionally corresponds to an object-interaction gesture including a pointing gesture directed at an object. For example, the object-interaction gesture optionally includes a pointing gesture by a finger (e.g., an index finger or optionally another finger) of a hand of the user (optionally also with the remaining fingers in a fist) pointing at object. In some examples, the object-interaction gesture includes touching the object or being within a threshold distance of the object. In some examples, performing the object-interaction gesture includes maintaining the pointing gesture (e.g., optionally with less than a threshold amount of movement, and/or optionally with gaze directed at the object or the hand) for a threshold amount of time. Although a pointing gesture is primarily shown and described herein, it is understood that the object-interaction gesture described herein is not so limited. In some examples, the electronic device provides relevant information related (e.g., displays the information as virtual content in a user interface or otherwise in a three-dimensional environment, and/or presents the information in an audible format) to the information identified and detected in the physical environment. In some examples, the electronic device is a head worn electronic device.

In some examples, the present disclosure provides efficient methods for applying processes (e.g., gating strategies) to limit undue execution of processes or operations until one or more criteria are satisfied, or one or more cues are detected. For example, one or more gating strategies are optionally used to limit undue execution of processes to detect an object-interaction gesture, and/or the additional processing necessary to perform the operations associated with the object-interaction gesture. By awaiting confirmation of satisfaction of criteria and/or detection of cues prior to executing subsequent operations, the present disclosure provides efficient gating strategies to limit unnecessary processes which are otherwise potentially costly with respect to processor tasking and power consumption.

In some examples, a method is performed at an electronic device in communication with one or more displays and/or a plurality of input devices including one or more motion sensors and one or more optical sensors. In some examples, the electronic device detects movement of the electronic device using one or more motion sensors. In some examples, the electronic device determines whether the movement of the electronic device satisfies one or more first criteria, including a criterion that is satisfied when the movement is less than a first threshold of movement (and/or including a criteria that is satisfied when the movement is greater than a second threshold of movement). When the electronic device determines that the one or more first criteria are met, the electronic device captures, via the one or more optical sensors, one or more first images of a physical environment. In some examples, when the electronic device determines that the one or more first criteria are met, the electronic device initiates tracking for a first portion of a user (e.g., a finger, and/or hand) of the electronic device (e.g., as part of detection of an object-interaction gesture) using the one or more first images. In some examples, when the electronic device detects, in the one or more first images, that the first portion of a user of the electronic device satisfies one or more second criteria, the electronic device allows the execution of subsequent operations. In some examples, following the determination that the one or more second criteria are met, the electronic device captures, via the one or more optical sensors, one or more second images of the physical environment, and subsequently, or simultaneously, initiates image processing of a portion of the one or more second images with processes such as, but not limited to, Optical Character Recognition (OCR), non-character recognition, graphical content searching, and Artificial Intelligence (AI) driven search. OCR, graphical content searching, and/or AI driven searching are optionally used to obtain information from the object of the object-interaction gesture and/or additional information associated with the object of the object-interaction gesture.

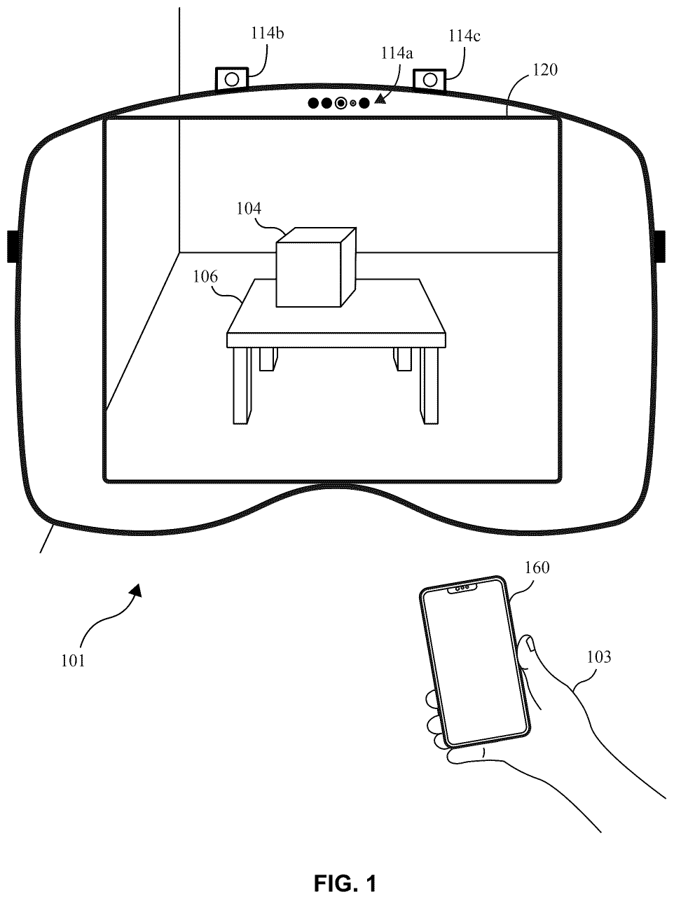

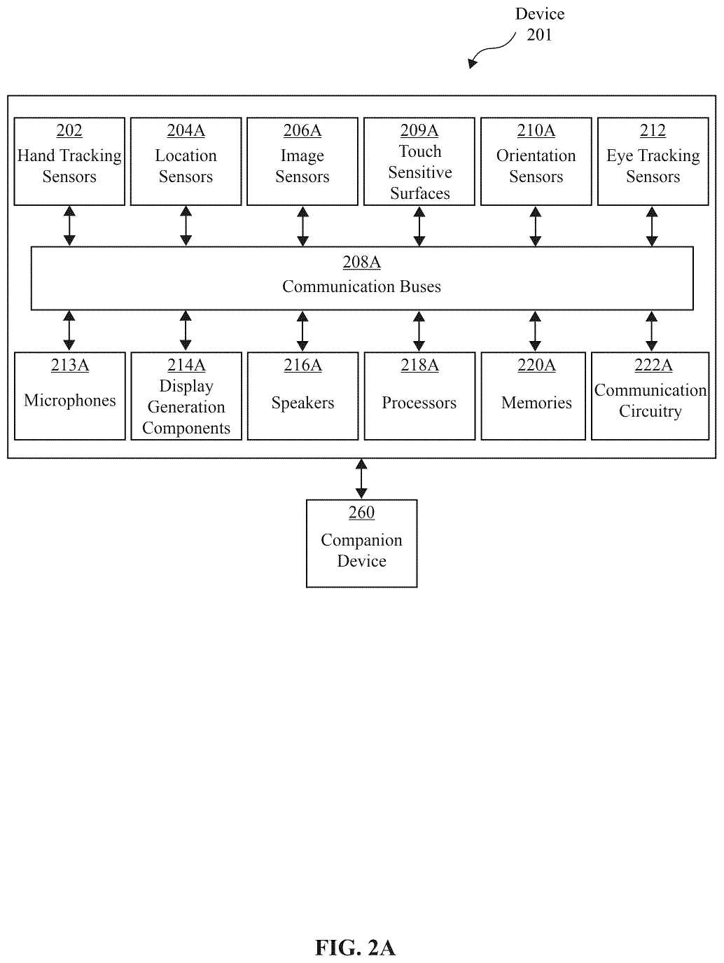

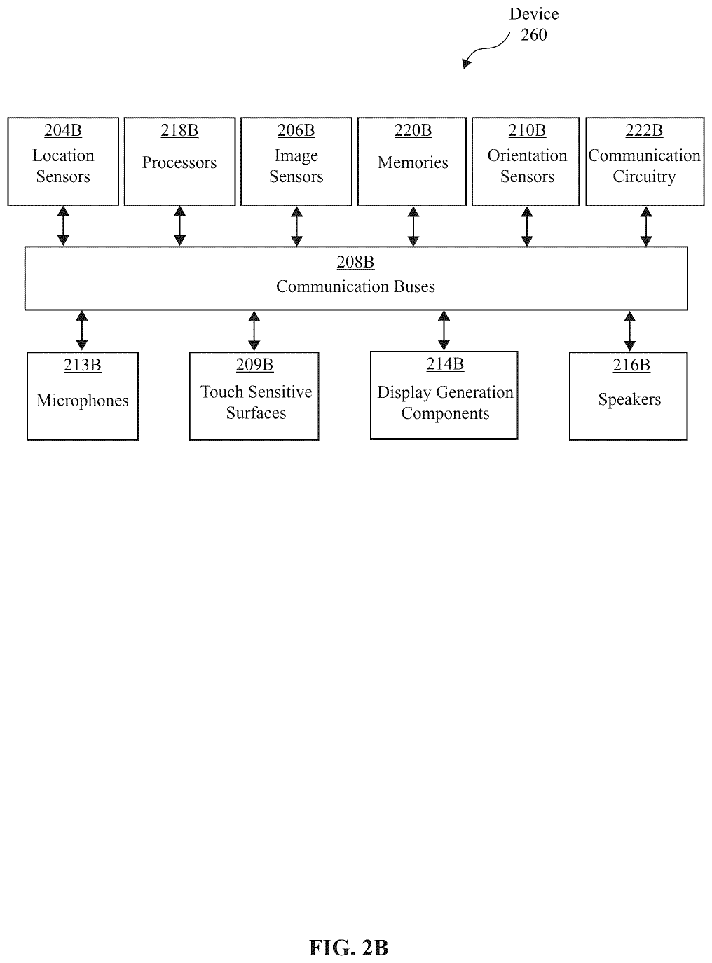

FIG. 1 illustrates an electronic device 101 presenting a three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specfies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards examples of interactions with one or more virtual objects that are displayed in a three-dimensional environment at one or more electronic devices (e.g., corresponding to electronic device 201 and/or 260). In some examples, while a physical environment is visible to the user of the electronic device, the electronic device visually detects one or more regions of the physical environment or objects of the physical environment. Optionally the region or object is indicated by a user through user input, such as an object-interaction gesture. In response to detecting the one or more regions of the physical environment, and in accordance with the one or more regions including first information (e.g., textual, and/or graphical), the electronic device optionally displays one or more user interface elements which include second information related to and/or based on characteristics of the first information.

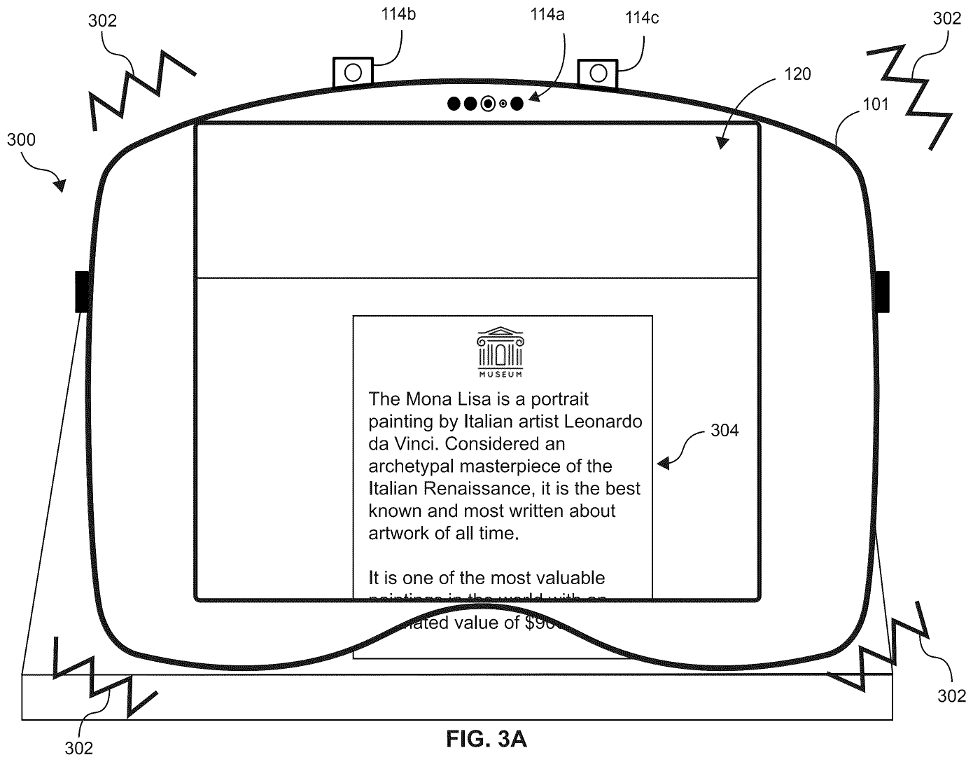

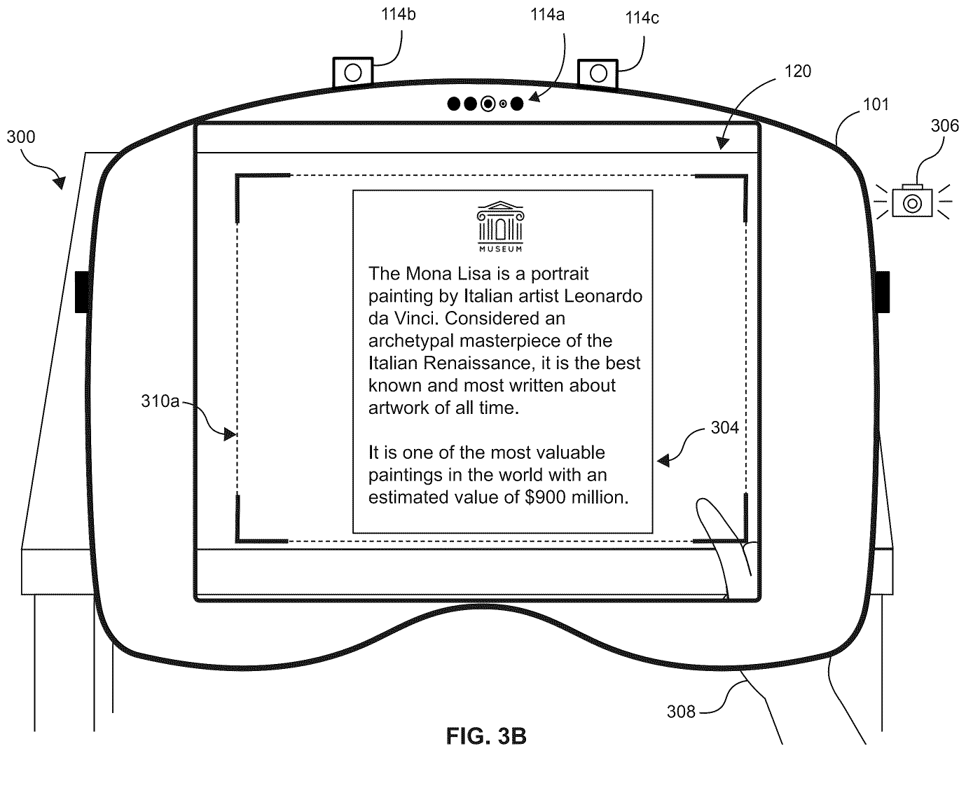

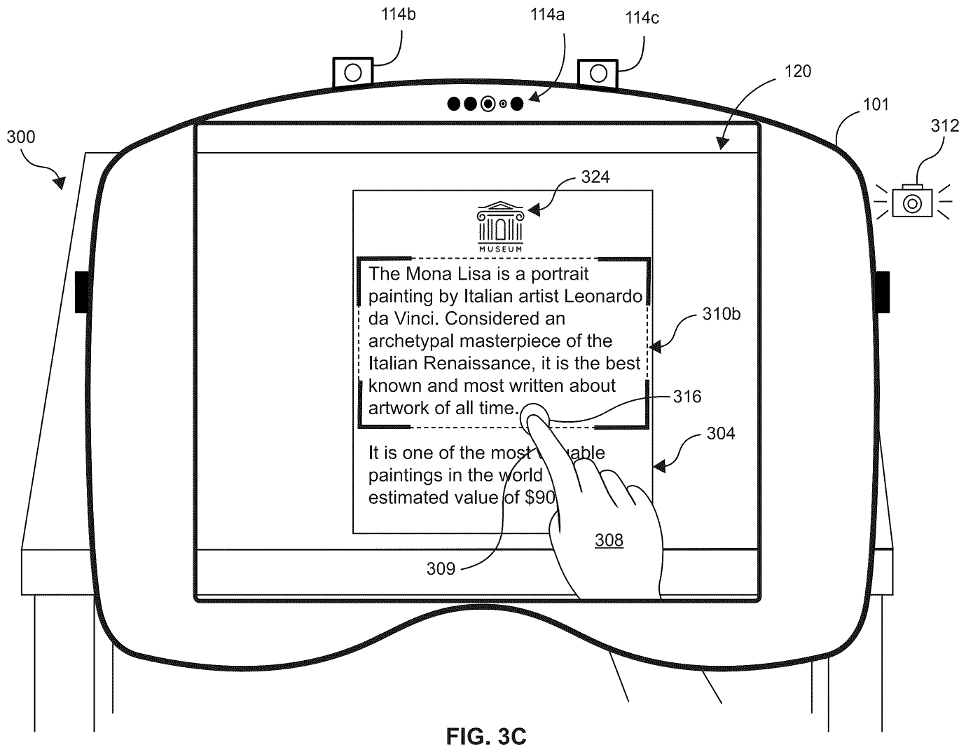

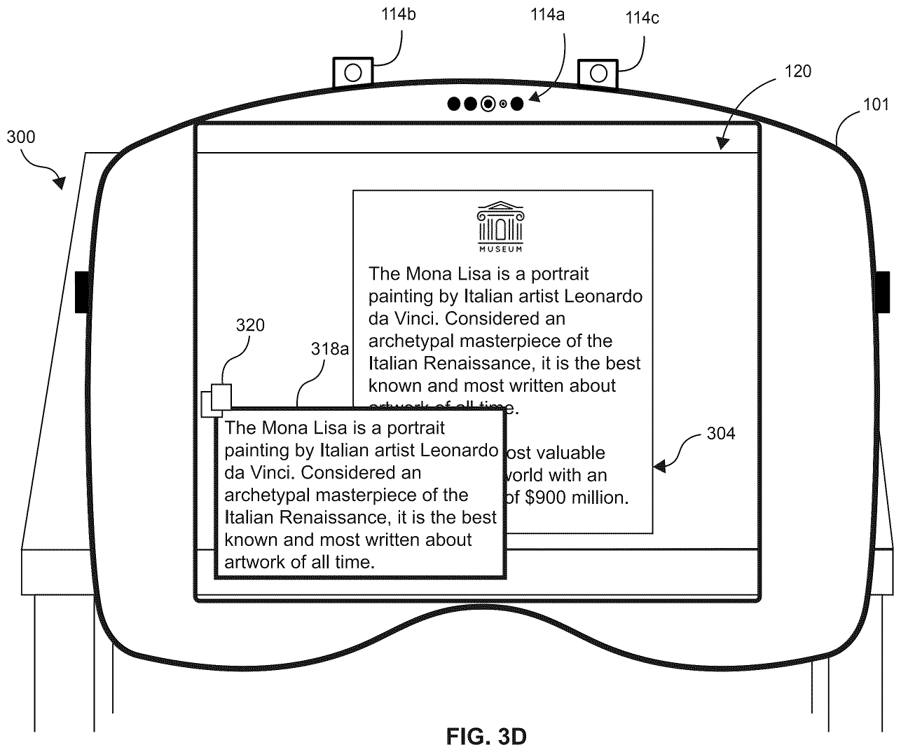

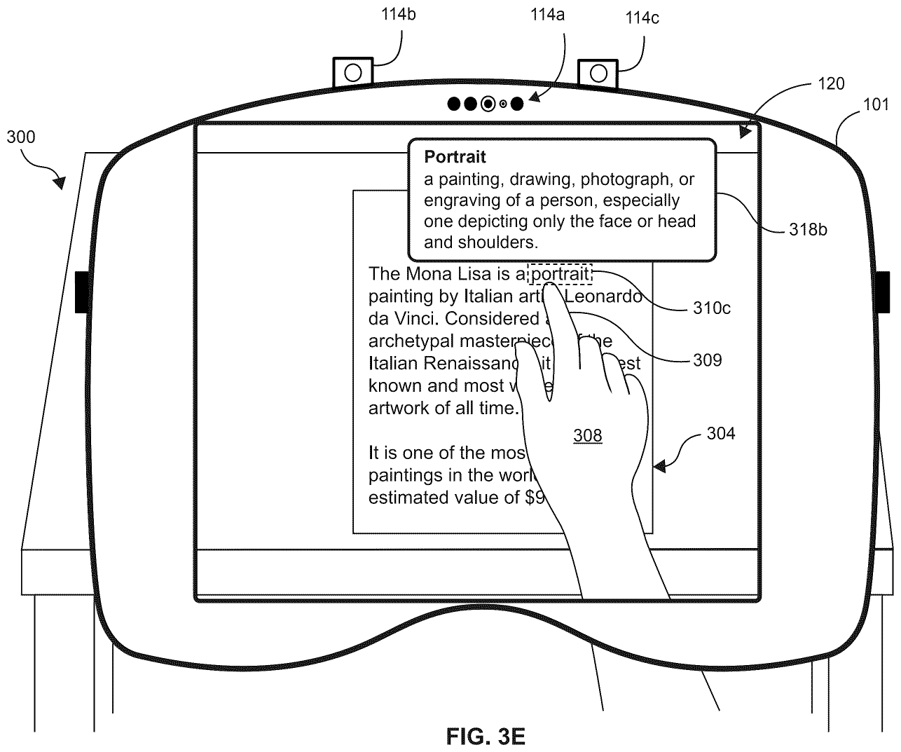

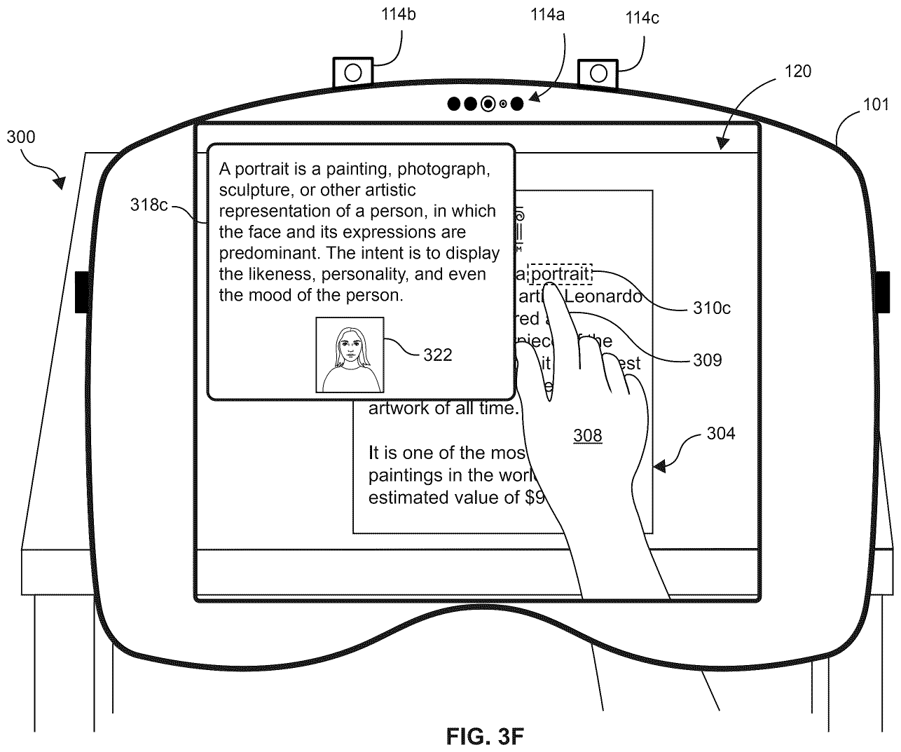

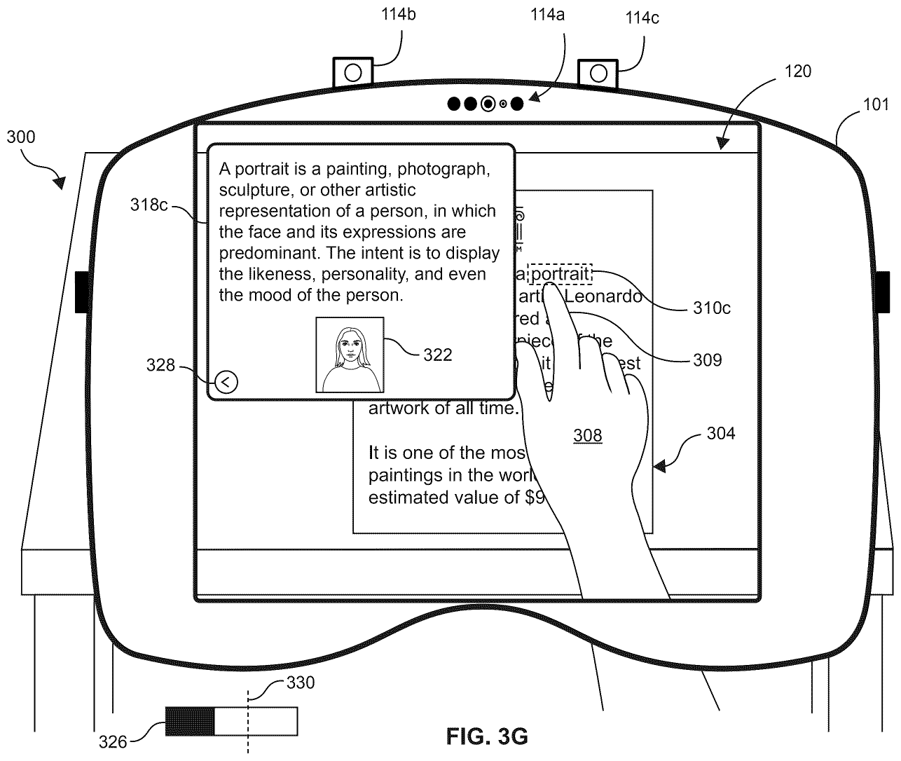

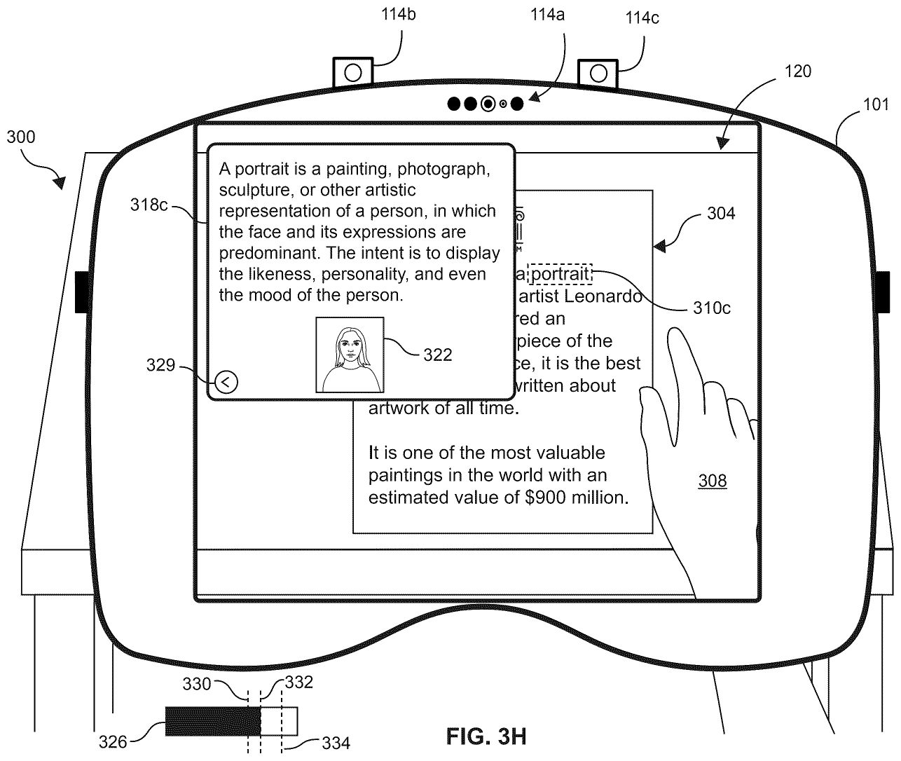

In some examples, an electronic device is in communication with one or more displays and/or a plurality of input devices including one or more motion sensors and one or more optical sensors. For example, electronic device, the one or more input devices, and/or the display generation component have one or more characteristics of the computer system(s), the one or more input devices, and/or the display generation component(s) described with reference to FIGS. 1-2. In some examples, the electronic device is configured to provide a view of a physical environment 300 (e.g., in FIG. 3A) surrounding a user, however the examples discussed herein are not limited thereto. In some examples, the electronic device uses one or more methods to interpret the movements of the electronic device, movements of the user (e.g., head movement, and/or hand movement), and/or gestures of the user (e.g., hand gestures) to exercise one or more gating strategies prior to initiating one or more operations to process informational content (e.g., textual information, and/or graphical information) associated with a physical environment. For instance, as illustrated in FIGS. 3A-3H, the electronic device 101 optionally captures one or more first images 306 after determining that detected movement 302 of the electronic device is less than a first threshold. In the one or more first images the electronic device 101 optionally detects for a hand of the user 308. When the electronic device 101 determines that the hand of the user 308 meets certain criteria (e.g., movement of the hand is less than a threshold of movement, and/or performing a gestures, such as the object-interaction gesture (e.g., extended finger 309) in the one or more second images, the electronic device 101 optionally initiates one or more image processing operations (e.g., OCR, graphical content recognition, etc.). Through the use of such gating strategies, the electronic device 101 optionally performs operations of increasing cost (e.g., processor cost, and/or power consumption), such as for detecting the object-interaction gesture and/or text or image processing/searching related to the object of the object-interaction gesture, only upon satisfying conditions and/or criteria which are based on less costly operations. Accordingly, in the event that one or more conditions and/or criteria are not satisfied, the electronic device forgoes more costly operations which are unnecessary.

In some examples, the electronic device detects, via the one or more motion sensors, movement of the electronic device to determine if movement 302 of the electronic device is below a first threshold of movement. When the movement 302 of the electronic device 101 is below a first threshold of movement, the electronic device optionally captures one or more first images 306. In the event that the electronic device 101 determines that the movement 302 of the electronic device is too high (e.g., above the first threshold), the electronic device 101 forgoes capturing the one or more first images 306 as the high motion of the electronic device indicates that capturing the one or more first images is unnecessary (e.g., the user's attention is unlikely to be directed to a region of interest and therefore unlikely to intend to direct an object-interaction gesture at an object, and/or the motion of the electronic device would result in unsatisfactory image quality for use in text recognition and/or graphical searching).

In some examples, as illustrated in FIG. 3A, the electronic device 101 detects the movement 302 of the electronic device to determine that movement 302 of the electronic device is above a second threshold of movement prior to initiating subsequent operations. For instance, determining that the electronic device 101 is above a second threshold of movement (e.g., not static), which is less than the first threshold of movement, indicates to the electronic device 101 that the electronic device 101 is worn by a user. When the electronic device 101 detects that the movement 302 of the electronic device is below a second threshold (e.g., static) the electronic device determines that the electronic device 101 is not worn by a user, and forgoes initiating subsequent operations such as the object-interaction gesture described herein.

The detecting of motion of an electronic device, such as the electronic device as illustrated in FIGS. 2A-2B, is optionally accomplished with the use of a motion sensor and/or orientation sensor 210 (often used interchangeably herein), such as an Inertial Measurement Unit (IMU). Additionally or alternatively, the electronic device optionally detects motion of the electronic device 201 through the use of one or more image sensors 206 (e.g., camera, Complementary Metal Oxide Semiconductor sensor, and/or Charge-Coupled Device sensor), wherein comparison of multiple images optionally indicates a movement of the electronic device based on the images, or differences in lighting optionally indicates motion of the electronic device as captured by the one or more images sensors. Through detecting the movement of the electronic device 201, the electronic device is able to determine whether performing subsequent operations or processes discussed herein associated with the object-interaction gesture is appropriate.

In some examples, when the electronic device 201 detects that the electronic device is static for a certain threshold of time (e.g., 5 seconds, 10 seconds, 30 seconds, 1 minute, etc.), the electronic device 201 optionally determines that the electronic device 201 is not being worn by a user and should therefore not perform subsequent actions to reduce power consumption (e.g., preserve battery life). Although detecting if the electronic device 101 is worn by a user is described in relation to movement 302 of the electronic device being above a second threshold of movement, additional or alternate methods of determining that the electronic device 101 is worn are within the spirit and scope of the present disclosure. In some examples, the electronic device 101 determines that the electronic device is worn by a user through the use of one or more sensors (e.g., one or more eye tracking sensors 212, and/or one or more orientation sensors 210A-210B). Furthermore, when the electronic device 201 detects that the electronic device is moving at a velocity greater than a first threshold for instance, thus indicating a low likelihood that the user's attention is focused on or intending to direct an object-interaction gesture at one or more objects or regions of an environment (e.g., physical environment), the electronic device optionally forgoes performing subsequent operations or processes to reduce power consumption. In some examples, when the electronic device 201 determines, via a motion sensor (e.g., orientation sensor 210), that the electronic device is moving less than a predetermined threshold or between two thresholds (e.g., not static, above a minimum, below a maximum, and/or combination thereof), the electronic device performs subsequent operations directed toward the methods discussed herein.

Detecting movements as described herein (e.g., movement of the electronic device, movement of a hand of the user, first movement threshold, second movement threshold, etc.) relates to movement over a predetermined time period optionally including measurements of displacement, velocity, and/or acceleration and comparison to corresponding movement thresholds. Examples of displacement measurements (e.g., displacement, and/or displacement threshold) include virtual distance based thresholds (e.g., 0 pixels, 1 pixel, 5 pixels, 10 pixels, 25 pixels, 50 pixels, 100 pixels, and/or more than 100 pixels) and/or real-world based distances (e.g., physical distances) including, but are not limited to, distances of: 0 mm (e.g., touching, nearly touching), 1 mm, 5 mm, 25 mm, 100 mm, 50 cm, 1 m, 3 m, or more than 3 m, etc. Examples of a predetermined time period include: less than 50 milliseconds, 50 milliseconds, 150 milliseconds, 0.5 seconds, 1 second, etc. Examples of a velocity (e.g., velocity, and/or velocity threshold) include virtual velocities (e.g., 0 pixels/s, 1 pixel/s, 5 pixels/s, 10 pixels/s, 25 pixels/s, 50 pixels/s, 100 pixels/s, and/or more than 100 pixels/s) and/or real-world based velocities (e.g., physical velocities) including, but are not limited to, velocities of: 0 mm/s, 1 mm/s, 5 mm/s, 25 mm/s, 100 mm/s, 50 cm/s, 1 m/s, 3 m/s, or more than 3 m/s, etc. Examples of acceleration (e.g., acceleration, and/or acceleration threshold) include virtual distance based accelerations (e.g., 0 pixels/s², 1 pixel/s², 5 pixels/s², 10 pixels/s², 25 pixels/s², 50 pixels/s², 100 pixels/s², and/or more than 100 pixels/s²) and/or real-world based accelerations (e.g., physical velocities) including, but are not limited to, accelerations of: 0 mm/s², 1 mm/s², 5 mm/s², 25 mm/s², 100 mm/s², 50 cm/s², 1 m/s², 3 m/s², or more than 3 m/s², etc.

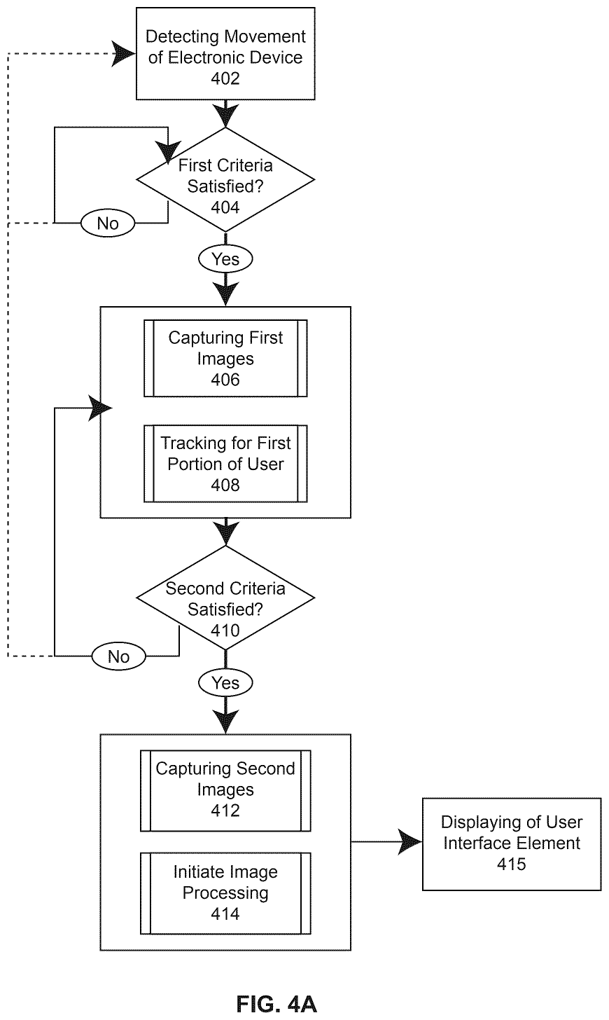

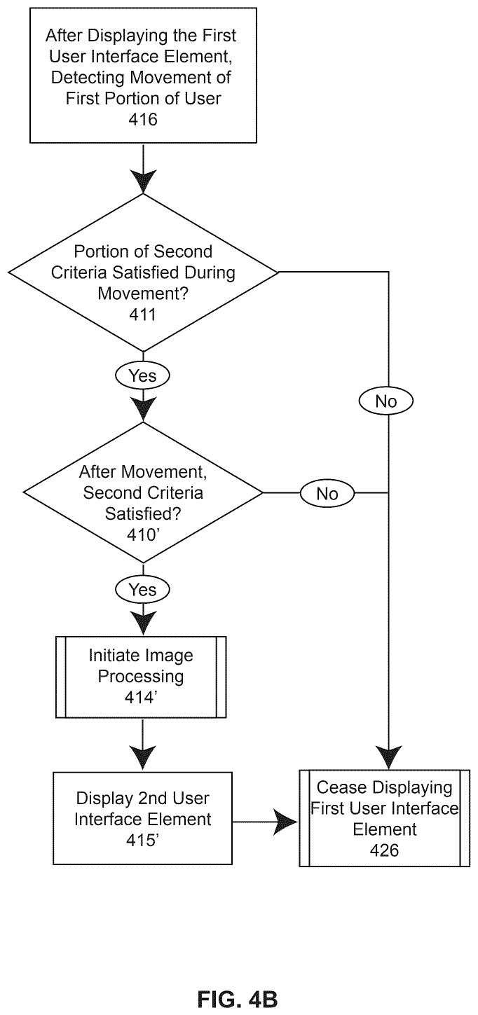

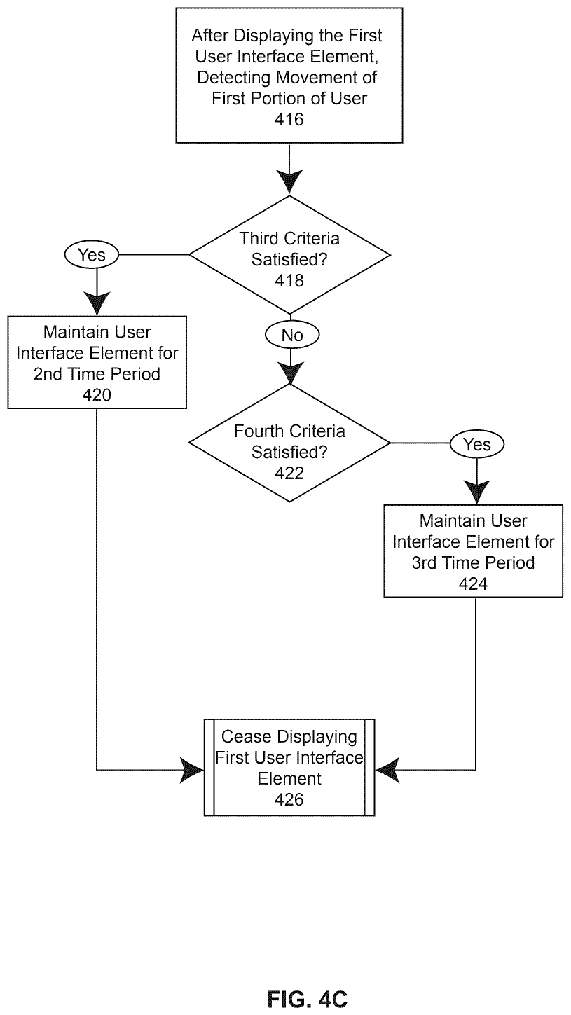

In some examples, as illustrated in the flow diagram of FIGS. 4A-4C of an exemplary process for an electronic device interacting with the physical environment, the detecting movement operation 402 occurs prior to the electronic device performing subsequent operations of the exemplary process. Upon the satisfaction of the one or more first criteria (e.g., detected movement of the electronic device meets threshold requirement(s)), the electronic device continues to perform subsequent operations of the process. In some examples, the detected movement 302 of the electronic device relates to rotational movement (e.g., rotational displacement over a predetermined time period, rotational velocity, and/or rotational acceleration) of the electronic device. Rotational movement of the electronic device 101 optionally corresponds to the movement of a user's head (e.g., forward and/or backward head tilting, lateral head rotation, and/or lateral head rotation). Examples of rotational displacement include, but are not limited to: 0.1 degrees, 0.5 degrees, 1 degree, 5 degrees, 10 degrees, etc. Examples of rotational velocity include, but are not limited to: 0.1 degrees/s, 0.5 degrees/s, 1 degrees/s, 5 degrees/s, 10 degrees/s, etc. Examples of acceleration include, but are not limited to: 0.1 degrees/s², 0.5 degrees/s2, 1 degrees/s², 5 degrees/s², 10 degrees/s², etc.

In some examples, a determination that the movement of the electronic device satisfies one or more first criteria, includes a criterion that is satisfied when the movement is less than a first threshold of movement (e.g., maximum threshold). By detecting that the movement of the electronic device is below a first threshold of movement, the electronic device is able to optionally determine that the attention of the user is directed to one or more objects.

In some examples, an electronic device 101 optionally awaits satisfying of one or more first criteria (e.g., corresponding to user wearing the electronic device, but with head remaining relatively stationary) prior to performing subsequent operations. In some examples, by detecting movement 302 of the electronic device illustrated in FIG. 3A, the electronic device determines whether the subsequent operations should be performed by the electronic device. For instance, in some examples, when the electronic device 101 detects movement 302 of the electronic device is below a threshold of movement (e.g., the maximum threshold), the electronic device 101 optionally performs subsequent operations associated with the methods described herein (e.g., object-interaction gesture and displayed information corresponding to the object). When the electronic device 101 detects that the movement 302 of the electronic device is below threshold of movement (e.g., the maximum threshold), the electronic device 101 optionally determines that the attention of a user is focused on one or more objects 304 presented via the one or more displays 120. For instance, when a user wearing an electronic device on their head looks around at an environment 300 (e.g., physical environment) without focusing their attention on a particular region or object typically exhibits a relatively higher amount of head movement compared with focusing attention on a particular region or object, which results in a relatively higher rate of electronic device movement 302. When a user wearing an electronic device 101 on their head focuses their attention on a region or object 304 within the physical environment and intends to perform an object-interaction gesture, the user's head typically remains static or reduces movement (e.g., the head is effectively stationary, subject to natural movement), which results in a relatively lower electronic device movement 302. Accordingly, in some examples, an electronic device 101 detects the movement 302 of the electronic device, and forgoes performing subsequent operations of the process prior to determining that one or more criteria dependent on the movement 302 of the electronic device are satisfied. For instance, when the movement 302 of the electronic device is below a maximum threshold, the electronic device 101 optionally performs subsequent operations. When the movement 302 of the electronic device is determined to be above a maximum threshold, the electronic device 101 forgoes performing subsequent operations and/or continues detecting the movement of the electronic device until the movement 302 of the electronic device is determined to be below the maximum threshold.

In some examples, the one or more first criteria include a criterion that is satisfied when the movement of the electronic device is above a minimum threshold (e.g., not static) to optionally differentiate between the focused attention of a user associated with performing an object-interaction gesture and the electronic device being static (e.g., electronic device being placed/positioned on a table or other surface). For instance, the electronic device 101 optionally exhibits levels of movement as related to the natural movement of a user's head even when the user's head is perceived as static by the user. In contrast, when the electronic device 101 is not worn by a user, the electronic device 101 is optionally static and exhibits no movement. Additionally or alternatively, in some examples, the first criteria include a criterion that is satisfied when there is no exclusion criterion (e.g., one or more microphones detecting that the user is engaged in a conversation, and/or detecting via one or more sensors that the user is sleeping). Detecting that the one or more first criteria are satisfied are optionally detected by the electronic device and/or by a second electronic device which is in digital communication with the electronic device (e.g., smart watch, smart phone, etc.). As illustrated in FIG. 4A for instance, in the event the electronic device determines that the first criteria are satisfied (at 404), the electronic device optionally continues to perform one or more subsequent operations of the exemplary process.

In some examples, the electronic device 101 captures, via the one or more optical sensors, one or more first images of a physical environment. FIGS. 3A-3H illustrate an exemplary physical environment 300 of a user wearing an electronic device 101, and interactions of the user with one or more regions and/or objects, such as object 304, within the physical environment. The exemplary physical environment 300 depicted includes an object 304, a museum placard (or text in a book), that provides information regarding a work of art (e.g., The Mona Lisa). It is understood that object 304 illustrated in FIGS. 3A-3H is an example, but other physical objects can be the subject of the object-interaction gesture described herein. Objects of the object-interaction gesture optionally include objects themselves (e.g., a book, a computer, a car, a sculpture) or a subset of an object such as text or and/or graphical representations (e.g., images, logos, drawings). FIGS. 3A-3H depict some examples of how a user optionally interacts (e.g., using the object-interaction gesture), in conjunction with the electronic device 101, with the informational placard to present additional information related to the information present within the physical environment. The information related to the informational content within the physical environment includes, but is not limited to: generating textual representations for subsequent operations processes (e.g., saving, copying, and/or pasting), generating graphical representations for subsequent operations (e.g., saving, copying, and/or pasting, generating and/or searching for definitions of one or more words, generating and/or searching for encyclopedic entries of one or more words, etc.). As used herein, the phrase “in conjunction with” optionally relates to co-related processes which occur prior to, in response to, simultaneously with, and/or subsequent to each other.

In some examples, as illustrated in FIG. 3B and FIG. 4A for instance, following the electronic device 101 determining that the one or more first criteria are satisfied (e.g., the electronic device 101 is moving above a threshold of movement, within a threshold of movement, and/or below a threshold of movement), the electronic device 101 initiates capturing (e.g., indicated at 406) one or more first images using one or more optical sensors (e.g., external image sensors 114b, 114c). In some examples, capturing (at 406) one or more first images include capturing images of a of the physical environment around the user which optionally includes physical objects (e.g., object 304 in FIG. 3B). The capturing (at 406) of one or more first images, in some examples, is used for the purposes of detecting inputs from a user (e.g., the object-interaction gesture) to provide one or more visual cues to the electronic device 101 to perform subsequent actions. As illustrated in FIG. 4A for instance, following the determination that the one or more first criteria are satisfied (at 404), the electronic device continues to perform subsequent actions including capturing one or more first images (at 406).

In some examples, the electronic device initiates tracking for a first portion of a user of the electronic device using the one or more first images. In some examples, the tracking for the first portion of the user is performed by the electronic device, and/or by a second electronic device or computer system which is in digital communication with the electronic device. In some examples, following the capturing of the one or more first images as illustrated in FIG. 3B (e.g., in response to the capturing of the one or more first images), the electronic device initiates tracking a portion of a user (e.g., at least a portion of a the hand of the user 308) in the one or more first images, wherein hand of the user 308 optionally provides visual cues and/or relates to satisfying of one or more second criteria. In some examples, tracking a hand of the user 308 involves searching for a hand. However, following the detection of a hand of the user 308, the tracking for a first portion of a user optionally includes tracking the detected first hand (e.g., the hand of the user 308), and/or optionally tracking for a second hand of the user. Further still, in some examples, the tracking for a first portion of a user includes identifying the first portion of the user (e.g., right hand, left hand). While examples described and illustrated generally surround the tracking of a hand of the user 308 of a user, tracking of other parts of a user (e.g., joints, fingers, arm, foot, leg, head) are within the spirit and scope of the present disclosure.

As illustrated in FIG. 4A, following the determination that the one or more first criteria are satisfied (at 404), the electronic device subsequently performs a tracking for a first portion of a user (at 408). The tracking for a first portion of a user (at 408) is optionally performed prior to, simultaneously with, and/or subsequent to the capturing of the one or more first images (at 406).

In some examples, the electronic device determines, in the one or more first images, when the first portion of a user of the electronic device satisfies one or more second criteria. In some examples, as illustrated in FIG. 3B, the electronic device 101 continues to track for the first portion of the user (e.g., the hand of the user 308) by continuing to capture (at 406) the one or more first images until the electronic device 101 determines that the hand of the user 308 further satisfies the one or more second criteria. The one or more second criteria are optionally based on the motion of the hand of the user 308 in relation to the electronic device 101, the motion of the electronic device 101 in relation to the physical environment 300, the motion of the hand of the user 308 in relation to the physical environment 300, and/or a combination thereof. In some examples, the one or more second criteria are satisfied when the hand of the user 308 is detected within a region which includes one or more objects (e.g., object 304). For instance, the one or more second criteria optionally include a criterion that is satisfied when the hand of the user 308 stops in relation to a first region 310a of the physical environment in the one or more first images. In some examples, the hand of the user 308 satisfies one or more second criteria based on a gesture (e.g., hand gesture) which indicates an association of the hand of the user 308 with a first region 310a and/or object 304 within the one or more first images. In some examples, the one or more second criteria optionally include a criterion that is satisfied while the one or more first criteria (e.g., concerning the movement of the electronic device 101, as discussed with reference to FIG. 3A) continue to be satisfied.

In some examples, the one or more second criteria optionally include a criterion that is satisfied when the electronic device 101 detects that the hand of the user 308 is static, or below a threshold of motion (e.g., maximum threshold of motion), associated with a first region 310a of the physical environment in the one or more first images. As used herein, “associated with” and the “association of” as related to a portion of a user refers to a portion of a user which is in proximity of (e.g., within a threshold distance of) an object or region captured in one or more images (e.g., first images, second images), and/or directed toward (e.g., a hand gesture) an area corresponding with the object or region captured in one or more images

A threshold distance, in some examples, refers to a physical threshold distance between a portion of the user (e.g., the hand of the user 308) and an object or location as it exists within the physical environment. Exemplary physical threshold distances include, but are not limited to, distances of: 0 mm (e.g., touching), 2 mm, 2 cm, 15 cm, 30 cm, etc. Furthermore, a threshold distance, in some examples, refers to a virtual threshold distance between the portion of the user (e.g., the hand of the user 308) and an object as displayed on the one or more displays 120. Exemplary virtual threshold distances include, but are not limited to, distances of: 0 pixels, 1 pixel, 5 pixels, 10 pixels, 25 pixels, 50 pixels, 100 pixels, and/or more than 100 pixels. Furthermore, in some examples, when the hand of the user 308 at least partially visually overlaps and/or occludes an object as displayed on the one or more displays 120, the hand of the user 308 is optionally determined to be within the threshold distance. In some examples, the threshold distance corresponds to a distance corresponding to the depth direction, and/or a distance corresponding to a direction in a plane orthogonal to the depth direction. Additionally or alternatively, in some examples, a gesture provided by a portion of a user (e.g., hand gesture, one finger extended, two fingers extended, three fingers extended, four fingers extended) is predetermined to correspond to one or more portions (e.g., region, quadrant, entire image, focal area) of one or more images (e.g., first images), thereby satisfying one or more of the one or more second criteria.

In some examples, the one or more second criteria comprise a criterion that is satisfied when a portion of a user (e.g., a finger) physically contacts an object captured in the one or more first images. For instance, when a finger of the hand of the user comes in contact with one or more words appearing on an object 304 (e.g., placard), a criterion of physical contact with an object is satisfied. As illustrated in FIG. 4A for instance, following the determination that the one or more second criteria are satisfied (at 410), the electronic device performs subsequent actions directed at the analysis of a region of interest associated with the first portion of the user (e.g., OCR of the text pointed to by the finger).

When identifying a first region corresponding to an object of interest in the physical environment, the electronic device optionally determines that the motion of the electronic device is below a first threshold of movement (e.g., as part of evaluating the one or more first criteria) prior to executing more power intensive operations such as tracking the hand of the user. Furthermore, upon tracking the hand of the user, a first region 310a is established, such as illustrated in FIG. 3B. As the motion of the hand of the user continues, the electronic device optionally updates the first region 310c, such as shown in FIG. 3C. When the electronic device detects that the hand of the user is below a second threshold of movement (e.g., one or more second criteria), the electronic device optionally performs one or more image processing operations (e.g., OCR). In some examples, the one or more image processing operations are performed by the electronic device, and/or by a second electronic device or computer system which is in digital communication with the electronic device. In some examples, the electronic device captures, via the one or more optical sensors, one or more second images of the physical environment. In some examples, as shown in FIG. 3C for instance, upon detecting that the first portion of the user (e.g., a hand of the user 308) meets the one or more second criteria (e.g., the hand of the user 308 is associated with an object 304 or first region 310b of the physical environment shown in the one or more images), the electronic device 101 initiates capturing one or more second images (e.g., indicated at 312), via the one or more optical sensors, of the physical environment 300. As shown, the first region 310b of the physical environment shown in FIG. 3C is updated from the first region 310a of the physical environment as shown in FIG. 3B. The updating of the first region of the physical environment is optionally contextually based wherein the first region corresponds to a region of interest based on contextual cues including: the location of the first portion of the user, the representation of the physical environment from the viewpoint of the user, and/or movements (e.g., displacement, velocity, and/or acceleration) of the first portion of the user. The updating of the first region corresponding to the region of interest optionally results in a size of the first region increasing, or decreasing. For instance, when the attention of the user is directed to the object 304, the first region 310a, the whole of the object 304 is within the first region 310a as shown in FIG. 3B. While the first region surrounds the whole object 304, and the attention of the user is detected as directed to a portion of the object 304, the first region is updated (310b) as shown in FIG. 3C. Accordingly, the updating of the first region optionally results in a decrease in size of the first region as shown when flowing between FIG. 3B to FIG. 3C. However, in some examples, the updating of the first region results in an increase in size of the first region as shown such as if flowing from FIG. 3C to FIG. 3B. In one or more examples, the first region of the physical environment is optionally updated with respect to the hand of the user 308 (e.g., in response to movement of the hand). For instance, the electronic device 101 optionally identifies a first region 310a (e.g., as shown in FIG. 3B) of the physical environment prior to determining the one or more second criteria are satisfied. Furthermore, the electronic device 101 optionally updates the first region 310b of the physical environment (e.g., as shown in FIG. 3C) until the one or more second criteria are satisfied. In some examples, for instance, the electronic device 101 updates the first region 310b until the detected first portion of the user (e.g., the hand of the user 308) is determined to be steady (e.g., movement of the hand is below a maximum threshold of movement) in relation to the electronic device 101 and/or the physical environment 300. However, in alternate examples, the first region 310b of the physical environment (FIG. 3C) is not identified until after the one or more second criteria are satisfied.

The one or more second images optionally provide views of one or more regions (e.g., first region 310b) of the physical environment associated with the hand of the user 308. Using the second images, the electronic device 101 optionally performs subsequent actions based on the analysis of the one or more second images. Actions performed by the electronic device 101 subsequent to the capturing (at 412) of the one or more second images are optionally directed to the first region 310b as determined when the one or more second criteria are satisfied. While examples discussed herein surround the capturing (at 412) of one or more second images following satisfying one or more second criteria, alternate examples wherein the one or more second images are captured in accordance with the detection of the first portion of the user are within the spirit and scope of the present disclosure. In some examples, in accordance with a determination that at least a portion of the first region 310b is obscured (e.g., by one or more portions of the user), the electronic device optionally performs image processing (at 414) on one or more of the first images 406 (e.g., the latest of the first images 406 when it is determined that second criteria are satisfied 410 and the first region 310b is unobscured) instead of on the one or more second images. For instance, with respect to FIG. 3C, when the one or more second criteria are satisfied and the one or more second images captured at 312 of the first region 310b are obscured by the hand of the user 308 of the user, the electronic device optionally performs the image processing (at 414) on the one or more first images 306 as shown in FIG. 3B. As illustrated in FIG. 4A for instance, following the determination that the one or more second criteria are satisfied (at 410), the electronic device subsequently captures one or more second images (at 412).

In some examples, the electronic device initiates image processing (e.g., OCR, non-character recognition, semantic recognition) of a portion of the second images corresponding to a first region of the physical environment. In some examples, after detecting that the one or more second criteria are satisfied (e.g., in response to the one or more second criteria being satisfied), the electronic device 101 initiates image processing of a portion (e.g., a first region 310b) in the one or more second images. The first region 310b of the physical environment, as shown in the one or more second images, is optionally associated with the location of the hand of the user 308. The image processing performed by the electronic device 101 determines relevant information in the region within the one or more second images associated with the hand of the user 308. For instance, the use of an optical character recognition (OCR) processing by the electronic device allows the electronic device to perform functions (e.g., copy, paste, define) related to one or more words within the identified region of the one or more second images. In some examples, image processing comprises the initiation of one or more non-character recognition processes (e.g., semantic search) for the recognition and searching of images or other graphics associated with the first region 310b of the physical environment detected in the one or more second images. In some examples, the image processing operation involves optionally applying one or more image processing methods and/or methods to determine the content of the information, and/or the nature of the information (e.g., textual, graphical, contextual) in the first region of the one or more second images captured by the electronic device. As illustrated in FIG. 4A for instance, following the determination that the one or more second criteria are satisfied (at 410), the electronic device 101 subsequently initiates an image processing operation (at 414) to analyze and determine information found within a first region 310b. The tracking for a first portion of a user (at 408) is optionally performed prior to, simultaneously with, and/or subsequent to the capturing of the one or more first images (at 406).

In some examples, as illustrated in FIGS. 3B, 3C, and 3E for example, the first region is determined by factors including the first portion of the user (e.g., the hand of the user 308, finger 309), a gesture performed by the first portion of the user (e.g., object-interaction gesture with pointing of finger 309), distance (e.g., virtual distance, or physical distance) of the first portion of the user from an object (e.g., object 304), contextual factors such as sentence or paragraph structure in the case of textual information, proximity of a first information element (e.g., word, sentence, paragraph, non-textual element) to a second information element, contextual links between adjacent words, or a combination thereof. As illustrated in FIG. 3B, for example, the hand of the user 308 is detected in association with object 304, wherein the distance of the hand of the user 308 from the object 304 is greater than the distance from the information elements displayed on the object 304, which causes the electronic device 101 to optionally establish the first region 310a as surrounding the whole of object 304. As the hand of the user 308 further approaches the object 304 (e.g., as the physical or virtual distance between the hand of the user 308 and the object 304 decreases), a gesture (e.g., an object-interaction gesture including extension and pointing of finger 309) is associated with a paragraph in the object 304 (e.g., as illustrated in FIG. 3C), such as when the distance from the extended finger 309 to the first paragraph is less than the distance of the first paragraph to an adjacent paragraph within the object 304, which causes the electronic device 101 to optionally establish the first region 310b as surrounding the first paragraph. In the event the extended finger 309 is associated with a first word (e.g., as illustrated in FIG. 3E), wherein the distance from the extended finger 309 to the first word is less than a distance of the first word from an adjacent word, the electronic device 101 optionally identifies the first region 310c as surrounding the first word.

In some examples, the one or more second criteria include a criterion that is satisfied when movement of the first portion of the user is less than a threshold velocity for at least a threshold amount of time. In some examples, as illustrated in FIG. 3C and FIG. 4A for instance, determining when the one or more second criteria are satisfied (at 410) includes detecting that the first portion of a user (e.g., a hand of the user 308) is moving at a velocity less than a threshold velocity, potentially indicating that the user's attention is drawn to a particular region or object of interest (e.g., first region 310b). In order to differentiate the velocity of the hand of the user 308 as an indication of an object of interest from a coincidental occurrence, in some examples, the tracking for the first portion of the user (at 408) optionally includes tracking an amount of time for which the hand of the user 308 moves less than the threshold velocity. In some examples, when the electronic device detects that the first portion of the user travels less than a threshold velocity for at least a threshold amount of time, the electronic device determines that the one or more second criteria have been satisfied.

In some examples, the one or more second criteria include a criterion that is satisfied when the first portion of the user is performing a predetermined gesture in the one or more first images. For example, the one or more second criteria are satisfied in accordance with a determination that the first portion of the user (e.g., hand of the user 308) is performing an extended finger gesture (e.g., via finger 309) as illustrated in FIG. 3C. In some examples, a gesture being performed by a hand of the user 308 which satisfies a criterion of the one or more second criteria optionally includes, but is not limited to, an extended index finger, an extended thumb in a “thumbs-up” gesture, one extended finger, and/or multiple extended fingers. In some examples, an electronic device optionally performs image processing based upon the gesture of the hand of the user 308.

In some examples, the electronic device initiates a process to determine that the first portion of the user is performing the predetermined gesture in response to detecting that a movement of the first portion of the user is less than the threshold velocity for at least the threshold amount of time.

Determining when a hand of the user 308 is performing a gesture can be a relatively intensive process for the processor, thus affecting processor bandwidth and power consumption. Accordingly, in some examples, only after the electronic device determines that the hand of the user is moving at a velocity less than a threshold velocity for at least a threshold amount of time, the electronic device initiates a process to determine when the hand of the user is performing the predetermined gesture. Performing such a process only after the electronic device 101 determines that motion of the hand of the user 308 is less than the threshold velocity for at least the threshold amount of time conserves processor bandwidth and power consumption, as one benefit. Furthermore, detection of a gesture made by a hand of the user requires more processing power when the hand of the user is moving at higher velocities. Accordingly, forgoing gesture recognition of a hand of the user 308 until the hand is determined to move below the velocity threshold further results in conserving processor bandwidth and conserving power.

In some examples, the one or more second criteria include a criterion that is satisfied when a finger of a hand of the user is pointing, such as in an extended position relative to other non-extended fingers of the hand. In some examples, as shown in FIG. 3C for instance, the one or more second criteria include a criterion that is satisfied when an index finger 309 of the hand of the user 308 is in an extended position. For instance, as shown, when the user's index finger 309 is in an extended position, the index finger 309 indicates a first region 310b of the physical environment to which the user's attention is directed. In some examples, identification of the first region 310b is not dependent upon the attention (e.g., gaze) of the user being directed toward a first region or the first portion of the user. Furthermore, in some examples, the attention of the user is not required to be directed toward the first region 310b in order to perform subsequent operations to the first region 310b as related to the methods disclosed herein. While examples shown herein surround the use of an extended index finger of the user in an extended position, alternate examples wherein the one or more second criteria include a criterion that is satisfied when a thumb, middle finger, ring finger, pinkie finger, or combination thereof are in an extended position, are within the spirit and scope of the present disclosure. Furthermore, in some examples, the user optionally programs the electronic device 101 to recognize a custom gesture, such as in the event the user is unable to perform one or more predetermined gestures.

In some examples, the one or more second criteria include a criterion that is satisfied when a finger of a hand of the user is in physical contact with the first region of the physical environment.

In some examples, the one or more second criteria include a criterion that is satisfied when a finger of the hand of the user (e.g., an index finger 309) is in physical contact 316 with the first region of the physical environment. For instance, as shown in FIG. 3C, the extended index finger 309 of the hand of the user is in physical contact with the object 304. In some examples, the physical contact of a finger of the user with an object 304 as part of the object-interaction gesture is interpreted as input to the electronic device 101 indicating a first region 310b of the object for subsequent processes. In some examples, a user's extended finger in contact with the object 304 indicates that the attention of the user is directed to the first region 310b indicated by and associated with the extended finger of the user.

In some examples, the electronic device performs image processing of first information in the one or more second images indicated by the first portion of the user satisfying the one or more second criteria. In some examples, as illustrated in FIGS. 3C-3D for instance, the electronic device 101 optionally performs image processing on the one or more second images captured (at 312) by the electronic device. The electronic device 101 optionally performs the image processing operations on a first region 310b of the physical environment, such as shown in association with an object 304, wherein the first region 310b has been indicated by, or is associated with, the first portion of the user (e.g., the hand of the user 308). As shown for instance in FIG. 3C, the extended index finger 309 of the user indicates a first region 310b of the object 304 comprising first information (e.g., textual information, graphical information). The image processing of the information found in the first region 310b provides analysis of the information found in the first region 310b.

In some examples, the electronic device displays, via the one or more displays, a first user interface element including second information associated with the first information. In some examples, after performing image processing on the first information found in the first region 310b, the electronic device 101 displays, via the one or more displays 120, a first user interface element 318a displaying second information associated with the first information found in the first region 310b, as shown in FIG. 3D. The location of the first user interface element 318a (FIG. 3D) is shown offset from the center of the first region 310b (at FIG. 3C). In some examples, the electronic device displays the first user interface element in a configuration which is centered on the first region, offset from the first region, near-touching, touching and/or obscuring a corner of the first region, coincident with a location corresponding to the object-interaction gesture, coincident with a location corresponding to physical contact of a portion of the user with the physical environment, based on the size of the object, and/or based on the location of the object. The second information displayed in the first user interface element 318a optionally includes textual information, graphical information, translations, definitions, encyclopedic information, and/or other information related to the first information found within the first region 310b indicated by the user. In some examples, as illustrated in FIG. 4A for instance, displaying (at 415) of a first user interface element occurs following the operation wherein the electronic device 101 initiates image processing (at 414). Additionally or alternatively, in some examples, the electronic device optionally presents an audio output via one or more speakers corresponding to the information optionally provided within the first user interface element.

In some examples, the first information includes textual information, wherein the electronic device performing the image processing includes performing optical character recognition on the textual information. In some examples, as illustrated in FIGS. 3C-3D for instance, the first information found within the first region 310b associated with the hand of the user 308 comprises textual information. Accordingly, the operation wherein the electronic device 101 initiates image processing (at 414 in FIG. 4A) comprises performing an optical character recognition process to recognize the textual content within the first region 310b.

In some examples, the second information includes at least a subset of the textual information of the first information. In some examples, as illustrated in FIGS. 3C-3D, the first user interface element 318a displays second information including at least a subset of the textual information detected in the first region 310b. In including at least a subset of textual information from the first region 310b within the second information displayed within the first user interface element 318a, the electronic device 101 provides information for review by a user and/or in preparation for subsequent operations. For instance, the first user interface element 318a optionally provides a magnified view of the second information to provide a user increased visibility of the information found in the first region 310b. Additionally or alternatively, the second collection is displayed to optionally indicate the textual content from the first region 310b which is committed to memory of the electronic device (e.g., copied) and/or subject to subsequent processes performed by the electronic device 101.

In some examples, the electronic device saves the first information to memory of the electronic device. In some examples, subsequent to or simultaneously with the initiating image processing (at 414) (e.g., OCR), the electronic device 101 saves the first information found within the first region 310b to memory 220 (e.g., in FIGS. 2A-2B), such as short-term memory storage (e.g., copy indicated by user interface element 320) wherein the user is able to export (e.g., paste) the first information into alternate applications/files on the electronic device 101, or into applications/files on alternate electronic devices. Additionally or alternatively, the electronic device 101 passively saves the second information to memory 220. In some examples, the electronic device saves information to memory 220 following an input from the user instructing the electronic device to save the information (e.g., first information, second information). Inputs to save information to memory 220, in some examples, optionally include input(s) received by the electronic device 101 via voice command, option selection (e.g., via touch input, mouse input, keyboard input), gesture from hand of the user 308, gesture via user's head movement, or a combination thereof. Additionally or alternatively, the electronic device actively saves information (e.g., first information, second information) to memory 220 subsequent to (e.g., in response to) an operation (e.g., initiating image processing (at 414)) wherein the electronic device does not require user input to initiate saving the information to memory.

In some examples, the second information associated with the first information includes a definition of the first information. In some examples, as illustrated in FIGS. 3E-3F for instance, the second information displayed in the first user interface element 318b includes a definition of the first information found in the first region 310c indicated by a hand of the user 308, and optionally by an extended index finger 309 of a hand of the user. As shown in FIG. 3E, the user's extended index finger 309 corresponds to a first region 310c surrounding a word (e.g., “portrait”). Accordingly, the first user interface element 318b optionally displays a definition of the word found within the first region.

In some examples, the first region 310c optionally includes multiple associated words, or a phrase, wherein the definition displayed in the first user interface element 318b displays a definition of the multiple associated words. Optionally, a definition of multiple associated words comprises a single definition surrounding the multiple words as a whole, and/or individual definitions for each term/word.

In some examples, the second information includes an encyclopedic description of the first information. In some examples, as illustrated in FIGS. 3E-3F for instance, the second information displayed within the first user interface element 318b comprises an encyclopedic description of the first information found within the first region 310c indicated by a hand of the user 308, and optionally by an extended index finger 309 of a hand of the user. Furthermore, in some examples, the electronic device 101 performs a process to recognize related terms adjacent to the first region 310c. For instance, when the user's index finger 309 indicated a first region 310c which surrounded the term “Mona” as shown, initiating image processing (at 414 in FIG. 4A) optionally includes a process to identify contextually related terms, such as “Lisa.” Accordingly, in such an event, the electronic device 101 displays, via the one or more displays 120, a first user interface element 318a which includes an encyclopedic description of the terms “Mona Lisa” such as shown in FIG. 3D for instance. In some examples, an encyclopedic description is optionally AI generated.

In some examples, the second information includes an image related to the first information. In some examples, as illustrated in FIGS. 3E-3F for instance, the second information displayed within the first user interface element 318c further comprises an image 322 related to the first information detected within the first region 310c. For instance, a dictionary-based definition of a term “portrait” included within the second information shown in the first user interface element 318c optionally includes a sample portrait demonstrating the style commonly associated with a portrait. Additionally or alternatively, an encyclopedic description of “Mona Lisa” displayed in the first user interface element 318a (e.g., in FIG. 3D) is optionally accompanied with an image of the Mona Lisa by Leonardo da Vinci.

In some examples, the first information includes graphical information, wherein the electronic device performing the image processing includes performing a semantic search of the graphical information. In some examples, the first region 310b identified by a user optionally includes graphical information. When a first region is determined to include one or more images, the electronic device 101 optionally conducts a semantic search during the initiating of image processing (at 414 in FIG. 4A) to determine further information related to the graphical image(s) 324 in FIG. 3C. For instance, referencing FIGS. 3C-3D, when the hand of the user 308 indicated a first region 310b in association with the graphical image 324 (e.g., “Museum” icon) shown at the top of the object 304, the electronic device 101 optionally performs a semantic search to display a first user interface element 318a which includes second information. In some examples, the first user interface element 318a optionally displays the graphical image detected within the first region 310b and further stores (e.g., copies) the graphical image 324.

In some examples, following the electronic device 101 determining that the one or more second criteria are met, and in conjunction with capturing one or more second images (at 412 in FIG. 4A), the electronic device 101 optionally initiates an image processing operation (at 414) to determine when the one or more second images include graphical information, and/or textual information. Determining the nature of the content of the first region 310b of the one or more second images allows the electronic device 101 to further determine what subsequent processes (e.g., OCR, semantic search) are appropriate when analyzing the first information found within the first region 310b indicated by the user.

In some examples, following initiating the image processing operation, the electronic device detects, in the one or more second images, the first portion of the user at a second region of the physical environment, wherein the second region is different from the first region of the physical environment discussed above. In some examples, when the electronic device detects the first portion of the user at the second region of the physical environment, the electronic device further determines that the movement of the electronic device continues to meet the one or more first criteria, and determines when the first portion of the user satisfies the one or more second criteria. Upon determining that the first portion of the user satisfies the one or more second criteria, the electronic device initiates image processing of one or more third images of the physical environment corresponding to the second region of the physical environment. Furthermore, when the electronic device determines that the second region of the physical environment contains third information, the electronic device subsequently displays, via the one or more displays, a second user interface element that includes fourth information associated with the third information.

In some examples, as illustrated in FIGS. 3C-3E for instance, in the event a first user interface element 318a in relation to first region 310b is displayed via the one or more displays 120 (e.g., in FIG. 3D) and the first portion of the user (e.g., hand of the user 308) moves away from the first region 310b, and the first portion of the user (e.g., hand of the user 308) is subsequently detected to be associated with a different region (e.g., first region 310c at FIG. 3E), the electronic device 101 displays a different user interface element (e.g., first user interface element 318c) comprising second information related to the different region (e.g., first region 310c). In some examples, the electronic device 101 optionally updates the content displayed within the first user interface element to include third information found within the second region. Alternatively, in some examples, the electronic device 101 optionally displays a second user interface element including third information found within the second region.

In some examples, in which the first user interface element 318a is updated, the electronic device 101 provides a notification or indication of updating to the user. The notification optionally includes, but is not limited to, haptic feedback, visual pulsing (e.g., rapid increase and/or decrease in scale) of the first user interface element 318a, color change, and/or audible notification.

In some examples, as described below with reference to FIG. 4C, the user interface displayed at 415 is dismissed when the object-interaction gesture ends or the hand of the user 308 is determined to no longer be associated with the first region of the object, or optionally after a time period subsequent to the object-interaction gesture ends or disassociation of the hand from the first region. In some examples, to re-display information about the object or to display information about a different region associated with the object, the object-interaction gesture is performed again and the gating strategies of FIG. 4A begin anew with operation at 402. In some examples, to improve user experience, the device optionally allows for the information associated with the object to be displayed more quickly when a user directs the object-interaction gesture at the same object or another portion of the same object under certain circumstances. In some examples, referencing FIG. 4B for instance, subsequent to capturing the one or more second images (at 412), initiating image processing (at 414), and displaying (at 415) of the user interface element, the electronic device 101 optionally continues capturing images and further performs a process of detecting movement of the first portion of the user (at 416), optionally while continuing to satisfy a portion of the second criteria 411 (e.g., while the hand remains in view, maintaining the pointing gesture, maintaining contact with the object, and/or maintaining stability of the head, but allowing for movement of the hand). For example as shown in FIG. 4B, detecting movement (at 416) of the first portion of the user after displaying of the user interface element (at 415), enables the user to update the region of interest for the object-interaction gesture and/or update the corresponding information displayed using user interface elements (e.g., first user interface element, second user interface element, etc.) based on the movements of the first portion of the user to a new portion of the object (or optionally a new object). For instance, when the electronic device detects that a portion of one or more second criteria are satisfied (at 411), the electronic device optionally enables movement of the portion of the user to a new portion of the object without requiring satisfaction of the gating strategies from scratch (e.g., hand tracking at 408 remains active and/or gesture recognition algorithm 510 remains active). For example, the portion of the second criteria can include a criterion that is satisfied when the hand remains in view, a criterion that is satisfied when the hand maintains an object-interaction gesture (e.g., a pointing gesture), a criterion that is satisfied when remaining in contact with the object, and/or a criterion that is satisfied when maintaining stability of the head (e.g., the one or more first criteria remain satisfied). However, the electronic device allows for at least some movement of the hand. After the movement of the portion of the user, the electronic device detects that the one or more second criteria are satisfied (at 410′ corresponding to 410). For example, the hand of the user comes to rest and performs the object-interaction gesture targeting at a different portion of the object, the electronic device optionally initiates image processing (at 414′ corresponding to 414), and displaying a second user interface element (at 415′ corresponding to 415). In some examples, the electronic device initiates image processing of one or more third images of the physical environment corresponding to the second region of the physical environment (e.g., the different portion of the object or another object) when the one or more second criteria are satisfied (at 410′). In accordance with a determination that the second region of the physical environment contains third information, the electronic device displays, via the one or more displays, a second user interface element that includes fourth information associated with the third information.

Additionally, in some examples, the electronic device displays the second user interface element in conjunction with ceasing to display the first user interface element 426 (e.g., cross-fade the first and second user interface elements). Additionally or alternatively, the electronic device optionally updates the first user interface element to include updated information instead of displaying a second, new, user interface element and ceasing to display the first user interface element.

In some examples, when the electronic device detects that a portion of one or more second criteria are not satisfied (at 411), or thereafter the entirety of one or more second criteria are not satisfied (at 410′), the electronic device optionally ceases to display the first user interface element (at 426), optionally after a time period subsequent to failing to satisfy the portion or entirety of the second criteria. For example, when the electronic device displays, via the one or more displays, the second user interface element, the electronic device dismisses the first user interface element. In some examples, when the electronic device 101 displays a second user interface element (e.g., different than the first user interface element), the electronic device 101 dismisses (e.g., ceases display of) the first user interface element in conjunction with displaying the second user interface element. In some examples, the first user interface element is optionally dismissed in advance of displaying the second user interface element. In some examples, the first user interface element is dismissed subsequent to the displaying of the second user interface element. Further still, in some examples, the first user interface element (e.g., 318a, 318b, or 318c) is dismissed simultaneously with the display of the second user interface element (e.g., 318a, 318b, or 318c).

In some examples, after ceasing to display the first user interface element, the electronic device optionally reverts to detecting movement of the electronic device (at 402) and/or determining whether the first criteria are satisfied (at 404) in FIG. 4A. In some examples, such as shown in FIG. 4A, when the electronic device reverts to capturing one or more first images (at 406) and/or tracking for the first portion of the user (at 408), the electronic device optionally reverts to detecting movement of the electronic device (at 402) to confirm that the electronic device continues to be below the threshold of movement (at 404) and is still worn by the user.

In some examples, as shown in FIG. 4C, for example, when the electronic device detects movement of the first portion of the user after displaying the first user interface element (at 416), the electronic device ceases to display the first user interface element (optionally when the portion of the second criteria is not satisfied during the movement).

For example as shown in FIG. 4C for instance, while the electronic device displays the first user interface element (at 416), the electronic device determines when the first portion of the user satisfies one or more third criteria (at 418), including a criterion that is satisfied when the first portion of the user ceases to be associated with the first region of the physical environment within a first time period after displaying the first user interface element. If the electronic device determines that the one or more third criteria are satisfied (at 418), the electronic device maintains the first user interface element for a second time period (at 420), prior to ceasing to display (at 426), in accordance with the first portion of the user ceasing to be associated with the first region.

In some examples, as illustrated in FIG. 3G for instance, when the electronic device 101 detects that one or more third criteria are satisfied, wherein the third criteria include a criterion that is satisfied when the hand of the user 308 is no longer associated with (e.g., no longer coincides with, is no longer in physical contact with, is no longer pointing toward) with the first region, the electronic device 101 ceases to display the first user interface element 318c. In some examples, the first user interface element 318c remains displayed during the first time period (e.g., represented by first time period 326) during which the hand of the user is associated with the first region 310c prior to satisfying the third criteria. In some examples, the dismissal of the first user interface element 318c occurs after a second time period (e.g., represented at 330) which is optionally dependent on the first time period 326 during which the hand of the user 308 is associated with the first region 310c.

In some examples, the first time period 326 is measured from the displaying of the first user interface element 318c, to the moment the hand of the user 308 is determined to no longer be associated with the first region 310c. However, in other examples, the first time period 326, corresponding to the length of time which the hand of the user 308 is associated with the first region 310c, is measured from alternate times within the method 400 (e.g., after satisfying the one or more second criteria (at 410), after capturing one or more second images (at 412), and/or after initiating image processing (at 414)).

In some examples, when the hand of the user 308 is determined by the electronic device 101 to no longer be associated with the first region 310c, and the first time period 326 is less than a threshold amount of time 330, the first user interface element 318c is dismissed after a second time period (e.g., the threshold amount of time 330). Examples of a second time period 328 include, but are not limited to: less than 0.1 seconds, 0.1 seconds, 0.5 seconds, 1 second, 2 seconds, 3 seconds, 5 seconds, 10 seconds, or longer than 10 seconds.

In some examples, as shown in FIG. 4C, for example, while the electronic device displays the first user interface element (at 416), the electronic device determines, in the one or more second images, whether the first portion of the user satisfies one or more fourth criteria (at 422). In some examples, the one or more fourth criteria include a criterion that is satisfied when the first portion of the user continues to be associated with the first region of the physical environment outside (e.g., in excess of) the first time period discussed above after displaying the first user interface element. If the one or more fourth criteria are satisfied, the electronic device optionally maintains the first user interface element for a third time period (at 424) from when the first portion of the user ceases to be associated with the first region, prior to ceasing to display (at 426), via the one or more displays, the first user interface element. Examples of a third time period 334 include, but are not limited to less than 0.1 seconds, 0.1 seconds, 0.5 seconds, 1 second, 2 seconds, 3 seconds, 5 seconds, 10 seconds, or longer than 10 seconds.

In some examples, as illustrated in FIG. 3H for instance, when the hand of the user 308 is determined by the electronic device 101 to no longer be associated with the first region 310c, and the first time period 326 is greater than a threshold amount of time 330, the first user interface element 318c is dismissed (e.g., ceases to be displayed) after a third time period (e.g., represented by 334, measured from the time 332 when the hand of the user is detected to no longer be associated with the first region. In some examples, the second time period 328 is greater than the third time period 334. However, in some examples, the third time period 334 is greater than the second time period 328. In some examples, the first user interface element is dismissed when a “back” affordance 329 or dismissal affordance, optionally displayed within the first user interface element, is selected by the user.

Referring back to FIG. 4A, the process proceeds to image processing at 414 when the various criteria of the gating strategies are satisfied. When the various criteria of one gate of the gating strategies are not satisfied (e.g., within a threshold period of time), method 400 optionally resets to the start with monitoring movement of the electronic device at 402 and evaluating the one or more first criteria representing a first gating strategy. In some examples, method 400 optionally remains in at current state (without reset) until the various criteria of the next gate of the gating strategies are satisfied. In some examples, after the electronic device initiates tracking for the first portion of the user of the electronic device using the one or more first images, the electronic device determines when the movement of the electronic device satisfies the one or more first criteria. After determining that the movement of the electronic device satisfies the one or more first criteria, when the electronic device detects, in the one or more first images, that the first portion of the user of the electronic device does not satisfy the one or more second criteria, the electronic device forgoes initiating the image processing.

In some examples, as illustrated in FIG. 4A for instance, following tracking for a first portion of a user (at 408), and in accordance with the electronic device detecting that the first criteria continues to be satisfied (at 404), in the event that a determination indicates that the first portion of the user fails to satisfy (at 410) the one or more second criteria, the electronic device forgoes capturing second images (at 412) and/or initiating image processing (at 414). Furthermore, in such cases, the electronic device optionally reverts to a previous operation in the method 400 in attempts to establish the satisfaction of the one or more second criteria (at 410), to detect movement of the electronic device (at 402), to determine whether one or more first criteria are satisfied (at 404), to capture one or more first images (at 406), or to track for a first portion of the user (at 408).

In some examples, the one or more second criteria include a criterion that is not satisfied when the first portion of the user is not detected in the one or more first images. Following initiating tracking of the first portion of the user of the electronic device using the one or more first images, the electronic device determines whether the movement of the electronic device satisfies the one or more first criteria. If the electronic device detects, in the one or more first images, that the first portion of the user of the electronic device does not satisfy the one or more second criteria, the electronic device forgoes capturing the one or more second images of the physical environment. In some examples, as illustrated in FIG. 4A for instance, in the event that a first portion of a user is not detected during the tracking operation 408, the second criteria (at 410) is not satisfied, and the electronic device forgoes capturing the one or more second images (at 412).

In some examples, after initiating tracking of the first portion of the user of the electronic device using the one or more first images, the electronic device determines whether the movement of the electronic device satisfies the one or more first criteria. After determining that the movement of the electronic device satisfies the one or more first criteria, when the electronic device determines, in the one or more first images, that the first portion of the user of the electronic device fails to satisfy the one or more second criteria, the electronic device forgoes capturing, via the one or more optical sensors, the one or more second images of the physical environment.

In some examples, as illustrated in FIG. 4A for instance, in the event that the movement of the electronic device satisfies the one or more first criteria (at 404), but the detected portion of a user fails to satisfy the one or more second criteria (at 410), the electronic device forgoes capturing the one or more second images (at 412) and optionally reverts to a previous operation of method 400.

In some examples, when an electronic device determines that the movement of the electronic device does not satisfy the one or more first criteria because the movement of the electronic device is greater than the first threshold of movement, the electronic device forgoes capturing, via the one or more optical sensors, the one or more first images of the physical environment.

In some examples, as illustrated in FIG. 4A for instance, the one or more first criteria (at 404) include a criterion that is satisfied when the detected movement of the electronic device (at 402) is below a first threshold of movement. In the event that the detected movement of the electronic device fails to meet the one or more first criteria (e.g., the electronic device movement is greater than a first threshold of movement), the electronic device forgoes performing subsequent operations, such as capturing the one or more first images (at 406). For example, the first threshold of movement sets a maximum threshold wherein a level of movement above the first threshold optionally indicates that the user's attention is not directed at a particular object or region. Accordingly, the electronic device foregoes performing subsequent operations, including capturing one or more first images (at 406) in the event that the movement of the electronic device is in excess of the first threshold of movement to conserve processor tasking and power consumption.

In some examples, the one or more first criteria include a second criterion that is satisfied when the movement of the electronic device is greater than a second threshold of movement. If the electronic device determines that the movement of the electronic device does not satisfy the one or more first criteria because the movement is less than the second threshold of movement, the electronic device forgoes capturing, via the one or more optical sensors, the one or more first images of the physical environment.

In some examples, as illustrated in FIG. 4A for instance, the one or more first criteria (at 404) further include a criterion that is satisfied when the detected movement of the electronic device (at 402) is greater than a second threshold of movement. In the event that the detected movement of the electronic device fails to satisfy the one or more first criteria (e.g., the electronic device movement is less than a second threshold of movement), the electronic device forgoes performing subsequent operations, such as capturing the one or more first images (at 406). For example, the second threshold of movement of the electronic device sets/establishes a minimum threshold wherein a level of movement below the second threshold optionally indicates that the device is not worn by a user (e.g., the user is asleep). Accordingly, the electronic device foregoes performing subsequent operations, including capturing one or more first images, in the event that the movement of the electronic device is below the second threshold of movement to conserve processor tasking and power consumption.

In some examples, the one or more motion sensors (e.g., one or more orientation sensors 210A-210B) as illustrated in FIGS. 2A-2B comprise an inertial measurement unit. An inertial measurement unit as used herein surrounds an electronic device which measures force, angular velocity, angular acceleration, and orientation using elements including but not limited to accelerometers, gyroscopes, and magnetometers.

In some examples, as described herein and as illustrated in FIGS. 1-5, the present disclosure relates to an electronic device 101 which is in communication with one or more input devices and optionally in communication with one or more displays 120, one or more processors 218, one or more programs (e.g., saved and executed from memory 220) for performing any one or the methods or scenarios described and illustrated herein.

In some examples, as described herein and as illustrated in FIGS. 1-5, the present disclosure surrounds a computer readable storage medium (e.g., memory 220) storing one or more programs therein. The one or more programs are optionally executed by one or more processors 218 in communication with one or more displays 120 and/or one or more device inputs (e.g., one or more hand tracking sensors 202, one or more location sensors 204A-204B, one or more image sensors 206A-206B, one or more touch sensitive surfaces 209A-209B, one or more orientation sensors 210A-210B, one or more eye tracking sensors 212, and/or one or more microphones 213A-213B.

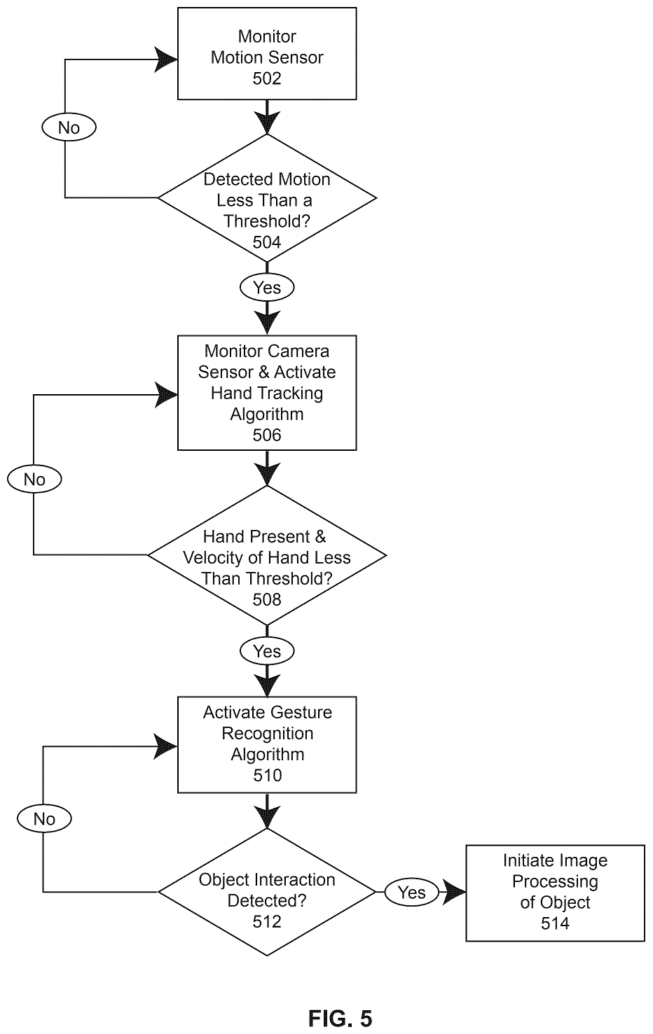

FIG. 5 illustrates a flow diagram for an example process 500 for gating processing algorithms of an electronic device in the context of the object-interaction gesture according to some examples of the disclosure. Process 500 corresponds to one implementation of method 400 including at least three gates before initiating image processing of an object (e.g., OCR of text of the object) that is subject to an object interaction-gesture. For example, the gating strategies include, at 502 (e.g., corresponding to 402), monitoring one or more motion and/or orientation sensors (e.g., motion and/or orientation sensors 210), to monitor motion of the head. At 504, a first gate evaluates whether motion of the electronic device worn on the head of a user is less than a threshold (e.g., corresponding to 404). When the motion of the wearable electronic device/head is less than the threshold (e.g., corresponding to satisfying one or more first criteria at 404), the electronic device, at 506, activates and/or monitors a camera sensor (e.g., one or more image sensors 206, one or more hand tracking sensors 202, e.g., corresponding to capturing one or more first images at 406), and activates a hand tracking algorithm (e.g., corresponding to tracking a first portion of the user at 406). The hand tracking algorithm optionally includes detecting the presence of the hand of the user, tracking position of joints of the hand of the user, and/or computing velocity of the hand and/or portions of the hand of the user (e.g., joints of the hand). When the motion of the wearable electronic device, corresponding to the motion of the head of the user, is not less than the threshold (e.g., corresponding to failing to satisfy the one or more first criteria at 404), the electronic device forgoes activating and/or monitoring the camera sensor (e.g., one or more image sensors 206, one or more hand tracking sensors 202), and/or forgoes activating a hand tracking algorithm. Thus, the relatively low power motion sensor and low power thresholding of the motion sensor optionally provides a first gate that avoids activating the relatively high power camera sensor and/or high power hand tracking algorithm when motion of the electronic /vice/ head indicates the user is unlikely to perform an object-interaction gesture described herein (e.g., low velocity of the hand correlates with pointing with the hand).

The gating strategies optionally further include, at 506, monitoring motion of the hand of the user. At 508, a second gate evaluates whether a hand of the user is present and whether motion of the hand (or portion thereof) of a user is less than a threshold (e.g., corresponding to 410). When the motion of the hand of the user is less than the threshold (e.g., corresponding to satisfying one or more second criteria at 410), the electronic device, at 510, activates a gesture recognition algorithm. When the motion of the hand of the user is not less than the threshold (e.g., corresponding to failing to satisfy the one or more second criteria at 410), the electronic device forgoes activating the gesture recognition algorithm. The gesture recognition algorithm optionally processes images (e.g., corresponding to the one or more first images captured at 406 and/or one or more second images captured at 412) to detect a gesture, such as the object-interaction gesture described herein. For example, the gesture recognition algorithm optionally uses the data from the hand tracking algorithm to detect position and/or motion of joints. Additionally or alternatively, the gesture recognition algorithm optionally detects the object of the object-interaction gesture. Thus, the relatively low power hand tracking algorithm and thresholding of the motion sensor optionally provides a second gate that avoids activating the relatively high power gesture recognition algorithm when motion of the hand indicates the user is unlikely to perform an object-interaction gesture described herein.

The gating strategies optionally further includes, at 510, monitoring for the object-interaction gesture using the gesture recognition algorithm. At 512, a third gate evaluates whether the gesture is performed (e.g., optionally corresponding to 410). When the object-interaction gesture is detected (e.g., optionally corresponding to satisfying one or more second criteria at 410), the electronic device, at 514, activates an image processing algorithm in support of the object-interaction gesture (e.g., corresponding to image processing at 414). When the gesture is not detected (e.g., optionally corresponding to failing to satisfy the one or more second criteria at 410), the electronic device forgoes activating the image processing algorithm. The image processing algorithm optionally processes images (e.g., corresponding to the one or more first images captured at 406 and/or one or more second images captured at 412) to detect text or graphical or semantic information to support fetching information in support of the object-interaction gesture described herein. Thus, the relatively low power gesture recognition algorithm optionally provides a third gate that avoids activating the relatively high power image processing algorithm (e.g., OCR) when the object-interaction gesture is not yet detected.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with a plurality of input devices including one or more motion sensors and one or more optical sensors:
detecting, via the one or more motion sensors, movement of the electronic device;
in accordance with a determination that the movement of the electronic device satisfies one or more first criteria, including a criterion that is satisfied when the movement of the electronic device is less than a first threshold of movement:
capturing, via the one or more optical sensors, one or more first images of a physical environment; and
initiating tracking for a first portion of a user of the electronic device using the one or more first images; and
in accordance with detecting, in the one or more first images, that the first portion of a user of the electronic device satisfies one or more second criteria:
capturing, via the one or more optical sensors, one or more second images of the physical environment; and
initiating image processing of a portion of the one or more second images corresponding to a first region of the physical environment.

2. The method of claim 1, wherein the one or more second criteria include a criterion that is satisfied when movement of the first portion of the user is less than a threshold velocity for at least a threshold amount of time.

3. The method of claim 1, wherein the one or more second criteria include a criterion that is satisfied when the first portion of the user is performing a predetermined gesture in the one or more first images.

4. The method of claim 1, wherein the one or more second criteria include a criterion that is satisfied when a finger of a hand of the user is in an extended position.

5. The method of claim 1, wherein the one or more second criteria include a criterion that is satisfied when a finger of a hand of the user is in physical contact with the first region of the physical environment.

6. The method of claim 1, wherein the image processing comprises image processing of first information in the one or more second images indicated by the first portion of the user satisfying the one or more second criteria, and wherein the method further comprises displaying, via one or more displays in communication with the electronic device, a first user interface element including second information associated with the first information.

7. The method of claim 1, further comprising, after initiating tracking for the first portion of the user of the electronic device using the one or more first images, and in accordance with the determination that the movement of the electronic device satisfies the one or more first criteria:
in accordance with detecting, in the one or more second images, that the first portion of the user of the electronic device fails to satisfy the one or more second criteria, forgo initiating the image processing.

8. The method of claim 1, further comprising, after initiating tracking of the first portion of the user of the electronic device using the one or more first images, and in accordance with the determination that the movement of the electronic device satisfies the one or more first criteria:
in accordance with detecting, in the one or more first images, that the first portion of the user of the electronic device fails to satisfy the one or more second criteria, forgoing capturing, via the one or more optical sensors, the one or more second images of the physical environment.

9. An electronic device, comprising:
one or more processors;
memory; and
one or more programs, wherein the one or more programs are stored in the memory and configured to be executed by the one or more processors, the one or more programs including instructions for:
detecting, via one or more motion sensors, movement of the electronic device;
in accordance with a determination that the movement of the electronic device satisfies one or more first criteria, including a criterion that is satisfied when the movement of the electronic device is less than a first threshold of movement:
capturing, via one or more optical sensors, one or more first images of a physical environment; and
initiating tracking for a first portion of a user of the electronic device using the one or more first images; and
in accordance with detecting, in the one or more first images, that the first portion of a user of the electronic device satisfies one or more second criteria:
capturing, via the one or more optical sensors, one or more second images of the physical environment; and
initiating image processing of a portion of the one or more second images corresponding to a first region of the physical environment.

10. The electronic device of claim 9, wherein the one or more second criteria include a criterion that is satisfied when movement of the first portion of the user is less than a threshold velocity for at least a threshold amount of time.

11. The electronic device of claim 9, wherein the one or more second criteria include a criterion that is satisfied when the first portion of the user is performing a predetermined gesture in the one or more first images.

12. The electronic device of claim 9, wherein the one or more second criteria include a criterion that is satisfied when a finger of a hand of the user is in an extended position.

13. The electronic device of claim 9, wherein the one or more second criteria include a criterion that is satisfied when a finger of a hand of the user is in physical contact with the first region of the physical environment.

14. The electronic device of claim 9, wherein the image processing comprises image processing of first information in the one or more second images indicated by the first portion of the user satisfying the one or more second criteria, and wherein the one or more programs further include instructions for displaying, via one or more displays in communication with the electronic device, a first user interface element including second information associated with the first information.

15. The electronic device of claim 9, the one or more programs including instructions for, after initiating tracking for the first portion of the user of the electronic device using the one or more first images, and in accordance with the determination that the movement of the electronic device satisfies the one or more first criteria:
in accordance with detecting, in the one or more second images, that the first portion of the user of the electronic device fails to satisfy the one or more second criteria, forgo initiating the image processing.

16. The electronic device of claim 9, the one or more programs including instructions for, after initiating tracking of the first portion of the user of the electronic device using the one or more first images, and in accordance with the determination that the movement of the electronic device satisfies the one or more first criteria:
in accordance with detecting, in the one or more first images, that the first portion of the user of the electronic device fails to satisfy the one or more second criteria, forgoing capturing, via the one or more optical sensors, the one or more second images of the physical environment.

17. A non-transitory computer readable storage medium storing one or more programs, the one or more programs comprising instructions, which when executed by one or more processors of an electronic device, cause the electronic device to:
detect, via one or more motion sensors, movement of the electronic device;
in accordance with a determination that the movement of the electronic device satisfies one or more first criteria, including a criterion that is satisfied when the movement of the electronic device is less than a first threshold of movement:
capture, via one or more optical sensors, one or more first images of a physical environment; and
initiate tracking for a first portion of a user of the electronic device using the one or more first images; and
in accordance with detecting, in the one or more first images, that the first portion of a user of the electronic device satisfies one or more second criteria:
capture, via the one or more optical sensors, one or more second images of the physical environment; and
initiate image processing of a portion of the one or more second images corresponding to a first region of the physical environment.

18. The non-transitory computer readable storage medium of claim 17, wherein the one or more second criteria include a criterion that is satisfied when movement of the first portion of the user is less than a threshold velocity for at least a threshold amount of time.

19. The non-transitory computer readable storage medium of claim 17, wherein the one or more second criteria include a criterion that is satisfied when the first portion of the user is performing a predetermined gesture in the one or more first images.

20. The non-transitory computer readable storage medium of claim 17, wherein the one or more second criteria include a criterion that is satisfied when a finger of a hand of the user is in an extended position.

21. The non-transitory computer readable storage medium of claim 17, wherein the one or more second criteria include a criterion that is satisfied when a finger of a hand of the user is in physical contact with the first region of the physical environment.

22. The non-transitory computer readable storage medium of claim 17, wherein the image processing comprises image processing of first information in the one or more second images indicated by the first portion of the user satisfying the one or more second criteria, and wherein the one or more programs further comprise instructions to display, via one or more displays in communication with the electronic device, a first user interface element including second information associated with the first information.

23. The non-transitory computer readable storage medium of claim 17, the one or more programs further comprise instructions to, after initiating tracking for the first portion of the user of the electronic device using the one or more first images, and in accordance with the determination that the movement of the electronic device satisfies the one or more first criteria:
in accordance with detecting, in the one or more second images, that the first portion of the user of the electronic device fails to satisfy the one or more second criteria, forgo initiating the image processing.

24. The non-transitory computer readable storage medium of claim 17, the one or more programs further comprising instructions for, after initiating tracking of the first portion of the user of the electronic device using the one or more first images, and in accordance with the determination that the movement of the electronic device satisfies the one or more first criteria:
in accordance with detecting, in the one or more first images, that the first portion of the user of the electronic device fails to satisfy the one or more second criteria, forgoing capturing, via the one or more optical sensors, the one or more second images of the physical environment.
